(19) United States
(12) Patent Application Publication
(10) Pub. No.: US 2023/0256581 A1
(43) Pub. Date: Aug. 17, 2023

(54) WORK TOOL AND ELECTRIC TOOL

(71) Applicant: MAKITA CORPORATION, Anjo-shi, Aichi (JP)

(72) Inventors: Akira MIZUTANI, Anjo-shi (JP); Masatoshi NAKAHAMA, Anjo-shi (JP); Daiki IMAIDA, Anjo-shi (JP)

(73) Assignee: MAKITA CORPORATION, Anjo-shi, Aichi (JP)

(21) Appl. No.: 18/012,827

(22) PCT Filed: Apr. 15, 2021
(86) PCT No.: PCT/JP2021/015588

§ 371 Date: Dec. 23, 2022

(30) Foreign Application Priority Data
Jul. 10, 2020 (JP) 2020-119280

(51) Int. Cl. B25F 5/02; B24B 23/02

(52) U.S. Cl. CPC B25F 5/02; B24B 23/02

(57) ABSTRACT

A work tool includes: a motor; a housing; an operation member extending in a longitudinal direction of the tool along the housing, configured to be pivotal about a pivotal axis by being subjected to a grip operation by a user, and exposed outside the housing on both first and second sides with respect to the pivotal axis; and a switch configured to detect that the operation member is moved to a first startup position in a first direction and to detect that the operation member is moved to a second startup position in a second direction opposite the first. The work tool is configured so that the motor is driven in a case where the pivotal movement to the first startup position is detected by the switch, and that the motor is driven in a case where the pivotal movement to the second startup position is detected by the switch.

### TECHNICAL FIELD

The present invention relates to a tool in which a motor is driven or stopped according to an operation on an operation member.

### BACKGROUND

A handheld-type work tool for proceeding with work using a driving force of a motor is equipped with a user interface for allowing a user to perform an operation of switching on/off actuation of the motor. An operation member subjected to a grip operation by the user is known as one type of such a user interface. The driving of the motor is started when the operation member is displaced from an initial position to a startup position according to the user's grip operation, and is stopped when the operation member is returned from the startup position to the initial position.

For example, in a grinder disclosed in PTL 1, which will be listed below, an operation member is provided so as to extend elongatedly along the lower surfaces of both a motor housing containing a motor and a rear cover located behind the motor housing. This operation member extends from approximately the rear half of the motor housing to around the rear edge of the rear cover. This operation member is biased toward an initial position by a biasing member. When a user performs a grip operation on the operation member, the operation member is moved pivotally with a pivot point therefor placed at the front end portion of this operation member (i.e., the end portion closer to the motor housing) against the biasing force exerted by the biasing member. When this displacement of the operation member is detected by a switch, the motor is driven and an accessory tool is rotated due to the rotational driving force of the motor.

### CITATION LIST

### [PTL 1] Japanese Patent Application Public Disclosure No. 2013-22702

### SUMMARY

However, the grinder discussed in PTL 1 leaves room for improvement of the operability of the operation member. For example, the user can excellently operate the operation member when holding the rear cover, but the operability is impaired when the user wants to hold a region near the accessory tool. More specifically, the operation member is moved pivotally with the pivot point therefor placed at the front end portion when the grip operation is performed thereon, and therefore the distance between the pivot point and the grip position reduces when the user holds the rear half of the motor housing. Therefore, the stroke amount of the operation member at the grip position reduces and the user's operational feeling is impaired. More specifically, the ON state and the OFF state of the switch are switched with a slight stroke amount, and this makes it difficult for the user to feel a sensation that the ON/OFF state is switched. In addition, when the stroke amount of the operation member is too small, the switch is undesirably switched to the OFF state contrary to the intention even with the user just slightly loosening the force gripping the operation member. Therefore, the user has to further firmly grip the operation member. Further, when wanting to hold the front side of the motor housing, the user cannot operate the operation member because the user's finger cannot reach the operation member. The above-described problems are not limited to the grinder discussed in PTL 1, and lie in common in any work tool including an operation member extending in a longitudinal direction along a housing and configured to be pivotal about a pivotal axis by being subjected to a grip operation by a user.

The present specification discloses a work tool. This work tool may include a motor, a housing, an operation member extending in a longitudinal direction of the work tool along the housing, configured to be pivotal about a pivotal axis by being subjected to a grip operation by a user, and exposed outside the housing on both a first side with respect to the pivotal axis and a second side opposite of the pivotal axis from the first side, and a switch configured to detect that the operation member is moved pivotally to a first startup position in a first direction and to detect that the operation member is moved pivotally to a second startup position in a second direction opposite from the first direction. The work tool may be configured in such a manner that the motor is driven in a case where the pivotal movement of the operation member to the first startup position is detected by the switch, and that the motor is driven in a case where the pivotal movement of the operation member to the second startup position is detected by the switch.

According to this work tool, the operation member is exposed outside the housing (i.e., the operation member is disposed in such a manner that the user can perform the grip operation) on both the first side with respect to the pivotal axis and the second side with respect to the pivotal axis, and therefore each of distances between the both end portions of the operation member with the pivotal axis interposed therebetween, and the pivotal axis of the operation member can be secured to some extent. Therefore, a stroke amount of the operation member at the grip position can be secured to some extent both when the user performs the grip operation on the first side of the operation member and when the user performs the grip operation on the second side of the operation member. Therefore, the operability of the operation member is improved.

### BRIEF DESCRIPTION OF THE DRAWINGS

FIG. 1 is a side view of a grinder according to a first embodiment of the present invention.

FIG. 2 is a plan view of the grinder.

FIG. 3 is a vertical cross-sectional view of the grinder, and illustrates a state in which an operation member is located at an initial position.

FIG. 4 is a perspective view of the operation member.

FIG. 5 is a vertical cross-sectional view of the grinder, and illustrates a state in which a grip operation is performed on the front side of the operation member and the operation member is moved pivotally from the initial position to a first startup position.

FIG. 6 is a vertical cross-sectional view of the grinder, and illustrates a state in which the grip operation is performed on the rear side of the operation member and the operation member is moved pivotally from the initial position to a second startup position.

FIG. 7 is a partial enlarged view of FIG. 3.

FIG. 8 is a partial enlarged view of FIG. 5.

FIG. 9 is a partial enlarged view of FIG. 6.

FIG. 10 is an exploded view of the grinder, and illustrates a state in which a left housing is removed.

FIG. 11 is an exploded view of the grinder, and illustrates a state in which the left housing and the operation member are removed.

FIG. 12 is a schematic view illustrating the positional relationship between an operation member, and a first switch and a second switch according to a second embodiment.

FIG. 13 is a schematic view illustrating an outline of the configuration of an operation member according to a third embodiment.

FIG. 14 is a schematic view illustrating an outline of the configuration of an operation member according to a fourth embodiment.

FIG. 15 is a side view of a grinder according to a fifth embodiment.

FIG. 16 is a perspective view illustrating an operation member according to the fifth embodiment.

FIG. 17 is a vertical cross-sectional view of the grinder, and illustrates a state in which the grip operation is performed on the upper side of the operation member and the operation member is moved pivotally from the initial position to the first startup position.

FIG. 18 is a vertical cross-sectional view of the grinder, and illustrates a state in which the grip operation is performed on the lower side of the operation member and the operation member is moved pivotally from the initial position to the second startup position.

FIG. 19 is a partial enlarged view of FIG. 18.

FIG. 20 is a partial enlarged view of FIG. 19.

### DETAILED DESCRIPTION OF THE EMBODIMENTS

A “housing” can be defined as a portion that contains one or more arbitrary component(s) selected from various components of a work tool. An operation member may be a single member. Alternatively, the operation member may include a first operation member disposed on a first side and a second operation member disposed on a second side. In this case, the first operation member and the second operation member may share a common single pivotal axis. Alternatively, the first operation member may have a first pivotal axis, and the second operation member may have a second pivotal axis. In other words, the first operation member may be configured to be pivotal about the first pivotal axis, and the second operation member may be configured to be pivotal about the second pivotal axis. In this case, the first operation member may be exposed outside the housing on the first side with respect to the first pivotal axis and the second pivotal axis, and the second operation member may be exposed outside the housing on the second side opposite of the first pivotal axis and the second pivotal axis from the first side.

In one or more embodiment(s), the first side may be one side with respect to the pivotal axis in the longitudinal direction. The second side may be an opposite side of the pivotal axis from the first side in the longitudinal direction. According to this configuration, each of distances between the both end portions of the operation member in the longitudinal direction, and the pivotal axis of the operation member can be secured to some extent. Therefore, a stroke amount of the operation member at the grip position can be secured to some extent both when the user performs the grip operation on the first side of the operation member in the longitudinal direction and when the user performs the grip operation on the second side of the operation member in the longitudinal direction. Further, the operation member can be disposed at an operable position even when the user holds a position near the tool accessory.

In one or more embodiment(s), the first side may be one side with respect to the pivotal axis in an intersection direction intersecting with the longitudinal direction. The second side may be an opposite side of the pivotal axis from the first side in the intersection direction. According to this configuration, a rotational radius and thus a stroke amount of the operation member at the grip position can be secured to some extent both when the user performs the grip operation on the first side of the operation member in the intersection direction and when the user performs the grip operation on the second side of the operation member in the intersection direction.

In one or more embodiment(s), the switch may include a first switch configured to detect that the operation member is moved pivotally to the first startup position, and a second switch configured to detect that the operation member is moved pivotally to the second startup position. According to this configuration, the ON states/OFF states of the first switch and the second switch can be switched directly utilizing the pivotal movement of the operation member. In other words, the present configuration does not require a transmission mechanism that transmits the displacement of the operation member to the switch. Therefore, the apparatus can be simply configured.

In one or more embodiment(s), the first switch may be disposed on the first side. The second switch may be disposed on the second side. According to this configuration, the first switch and the second switch do not have to be collectively placed on one side with respect to the pivotal axis, and therefore a layout of the work tool capable of preventing or minimizing a size increase can be easily set.

In one or more embodiment(s), the operation member may include a hinge constituent portion forming a part of a hinge for pivotally moving the operation member. According to this configuration, the operation member can be held at the predetermined position and can also be smoothly pivotally moved with a simple configuration.

In one or more embodiment(s), the hinge constituent portion may be a shaft portion extending in a direction in which the pivotal axis extends. The shaft portion may be rotatably supported in a boss formed in the housing. According to this configuration, the work tool can be easily assembled in a case where the housing is configured to be divisible such as being formed by half-divided members. According to another embodiment, the hinge constituent portion may be a boss portion surrounding around a shaft portion formed on the housing so as to extend in the direction in which the pivotal axis extends.

In one or more embodiment(s), the operation member may be a single member. According to this configuration, the number of parts reduces and the apparatus can be simply configured. Further, this configuration allows the user to easily understand the operation method.

In one or more embodiment(s), the work tool may include a lock-off member configured to be displaceable between a blocking position, at which the lock-off member blocks the operation member from being displaced to the first startup position and the operation member from being displaced to the second startup position, and a permission position, at which the lock-off member permits the operation member to be displaced to the first startup position and the operation member to be displaced to the second startup position. According to this configuration, the motor can be prevented from being driven contrary to the user's intention due to the user's accidental touch on the operation member.

In one or more embodiment(s), the lock-off member may include a first lock-off member and a second lock-off member. The first lock-off member may be configured to be pivotally moved integrally with the operation member, may be disposed on the first side, and may be displaceable between a first blocking position, at which the first lock-off member is engaged with the housing, thereby blocking the operation member from being displaced to the first startup position, and a first permission position, at which the first lock-off member is not engaged with the housing, thereby permitting the operation member to be displaced to the first startup position. The second lock-off member may be configured to be pivotally moved integrally with the operation member, may be disposed on the second side, and may be displaceable between a second blocking position, at which the second lock-off member is engaged with the housing, thereby blocking the operation member from being displaced to the second startup position, and a second permission position, at which the second lock-off member is not engaged with the housing, thereby permitting the operation member to be displaced to the second startup position. According to this configuration, the lock-off function can be provided with a simple configuration.

In one or more embodiment(s), the work tool may include a tool accessory configured to be driven by the motor. The housing may include a motor housing containing the motor therein, and a handle housing configured to be hold by the user, located adjacent to the motor housing on an opposite side from the tool accessory in the longitudinal direction, and extending in the longitudinal direction. The operation member may include a first portion extending in the longitudinal direction along the motor housing, and a second portion extending in the longitudinal direction along the handle housing. Expected usages of the above-described work tool are that the user holds the handle housing and that the user holds the motor housing located closer to the accessory tool according to the user's preference or the type of the work. According to this configuration, the stroke amount of the operation member at the grip position can be secured to some extent in any of these two cases. Therefore, the operability of the operation member is improved.

In one or more embodiment(s), an outer circumferential length of the handle housing around the longitudinal direction may be smaller than an outer circumferential length of the motor housing around the longitudinal direction. The operation member may include a connection portion extending in a direction intersecting with the longitudinal direction so as to follow a difference between the outer circumferential length of the handle housing and the outer circumferential length of the motor housing, thereby connecting the first portion and the second portion. The pivotal axis may be located at the connection portion. According to this configuration, the handle housing and the second portion are relatively small in outer circumferential length, and therefore the user can easily perform the operation of gripping the second portion while holding the handle housing. Further, normally, the user does not hold the boundary between the motor housing and the handle housing (i.e., a portion of the housing where the outer circumferential length changes). Therefore, according to the present embodiment in which the pivotal axis is located at the connection portion, a long distance can be secured in the longitudinal direction between the pivotal axis and the portion at which the user performs the grip operation on the operation member both when the user holds the motor housing and when the user holds the handle housing. Therefore, a great stroke amount of the operation member can be secured at the grip position. In other words, excellent operability of the operation member can be acquired both when the user holds the motor housing and when the user holds the handle housing.

In one or more embodiment(s), the housing may include an annular portion. The operation member may have an annular shape along an inner side of the annular portion. The pivotal axis may be located at an end portion of the operation member in the longitudinal direction. According to this configuration, the number of parts reduces and the apparatus can be simply configured.

In one or more embodiment(s), at least one of the first switch and the second switch may be located at a position where it is pressed by one of an end portion of the first side and an end portion of the second side of the operation member when the operation member is moved pivotally. According to this configuration, the distance between the portion of the operation member that presses at least one of the first switch and the second switch, and the pivotal axis increases. The displacement amount of the operation member due to the pivotal movement increases at a portion farther away from the pivotal axis. Therefore, according to this configuration, a greater displacement amount can be necessitated to cause the operation member to press at least one of the first switch and the second switch to bring it into the ON state. Therefore, an erroneous operation is less likely to occur with respect to at least one of the first switch and the second switch. Alternatively, the required precision of the dimension or the assembling of the work tool can be eased.

In one or more embodiment(s), an electric tool may include a motor, a power transmission mechanism connected to the motor, a motor housing containing the motor therein, a handle housing configured to be held by a user, a gear housing containing the power transmission mechanism therein, a tool accessory holding portion connected to the power transmission mechanism, and an operation member. The operation member may extend in a longitudinal direction of the work tool along the motor housing and the handle housing, have a pivotal center, and be configured to be pivotal about the pivotal center by being subjected to a grip operation by the user. The handle housing may have a smaller diameter compared to the motor housing, and may include a connection portion connecting the handle housing and the motor housing. The electric tool may be configured in such a manner that the pivotal center is located at the connection portion. Normally, the user does not hold a portion of the housing where the diameter changes. Therefore, according to this electric tool, a long distance can be secured between the pivotal center and the portion at which the user performs the grip operation on the operation member in the longitudinal direction both when the user holds the handle housing and when the user holds the motor housing. Therefore, a stroke amount of the operation member at the grip position can be secured to some extent. That is, excellent operability of the operation member can be acquired both when the user holds the motor housing and when the user holds the handle housing.

In one or more embodiment(s), the handle housing may be off-centered upward from the motor housing. The pivotal center may be located at a lower portion of the connection portion. According to this configuration, the grip operation can be easily performed on the operation member.

In one or more embodiment(s), the operation member may include a first portion and a second portion. The first portion may include a first end portion located on a first side with respect to the pivotal center in the longitudinal direction, and extend in the longitudinal direction along the motor housing. The second portion may include a second end portion located on a second side opposite of the pivotal center from the first end in the longitudinal direction, and extend in the longitudinal direction along the handle housing. The first portion may be shaped in such a manner that a protrusion amount of the first portion from the motor housing is maximized at a position of the first end portion. The second portion may be shaped in such a manner that a protrusion amount of the second portion from the handle housing is maximized at a position of the second end portion. According to this configuration, the orientation of the exposed portion of the operation member when the user grips the operation member becomes closer to the horizontal direction both when the user performs the grip operation on the first portion and when the user performs the grip operation on the second portion. Therefore, the user's operational feeling in a state of firmly gripping the operation member is improved. In other words, the user can easily maintain a state of gripping the operation member, i.e., a state of driving the motor.

In the following description, the embodiments of the present invention will be described in further detail with reference to the drawings. In the embodiments that will be described below, a handheld-type electric disk grinder (hereinafter simply referred to as a grinder) will be cited as an example of a work tool.

In the following description, the embodiments of the present invention will be described in further detail with reference to the drawings. In the embodiments that will be described below, a handheld-type electric disk grinder (hereinafter simply referred to as a grinder) will be cited as an example of a work tool including a housing, a motor, and an operation member.

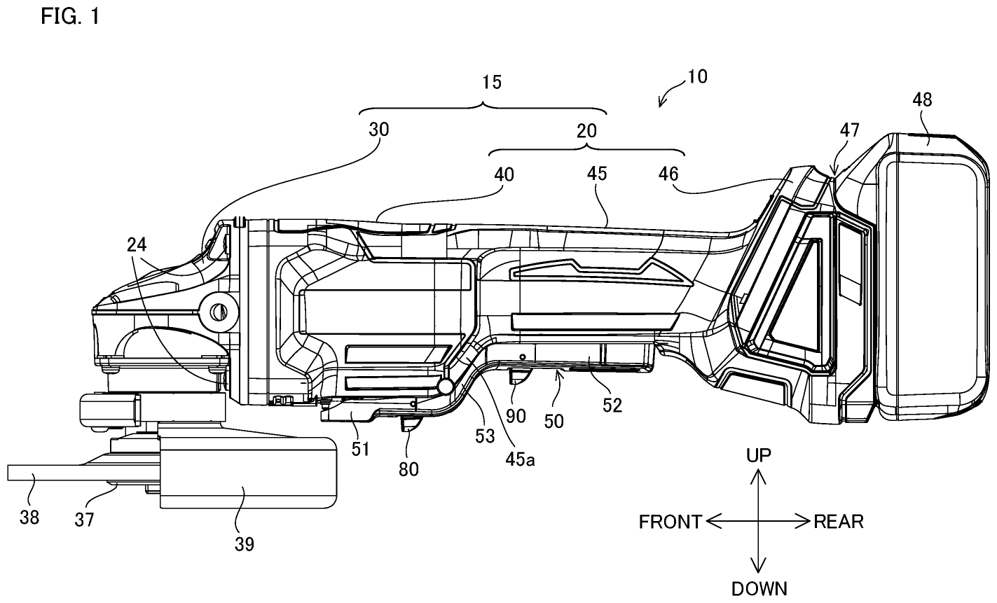

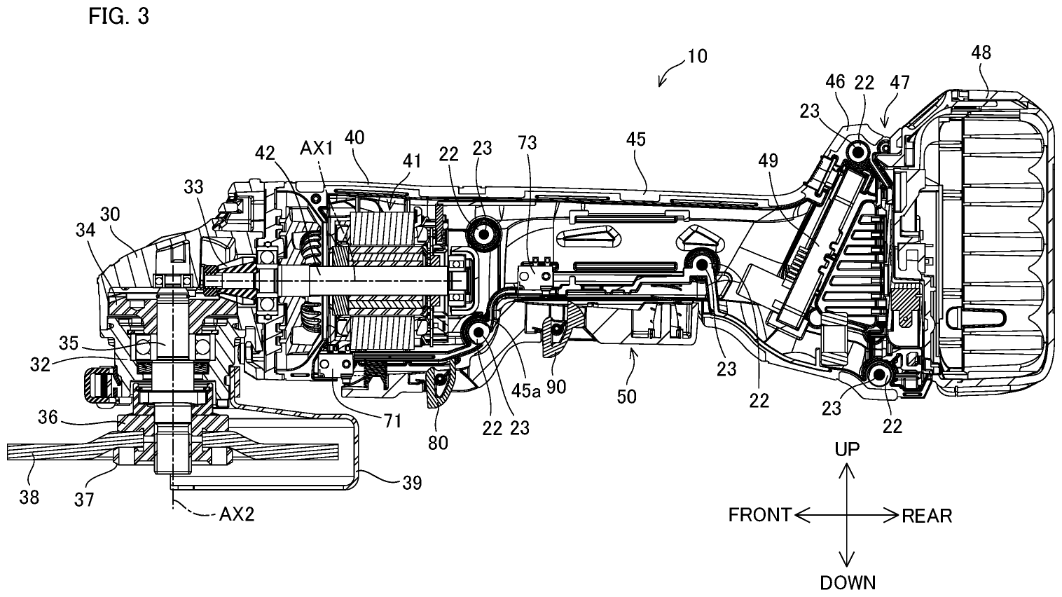

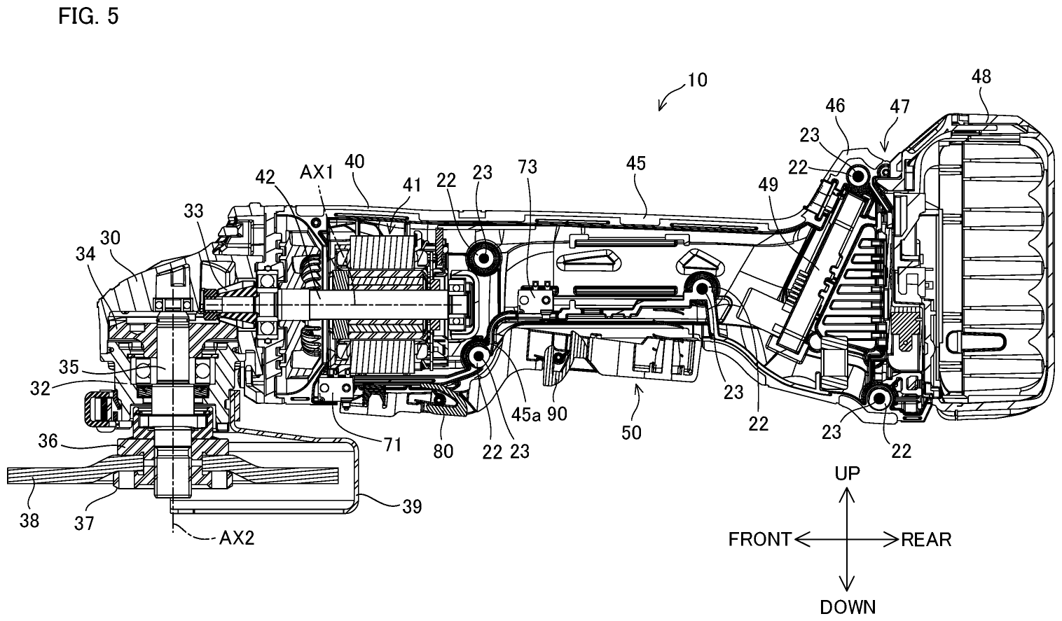

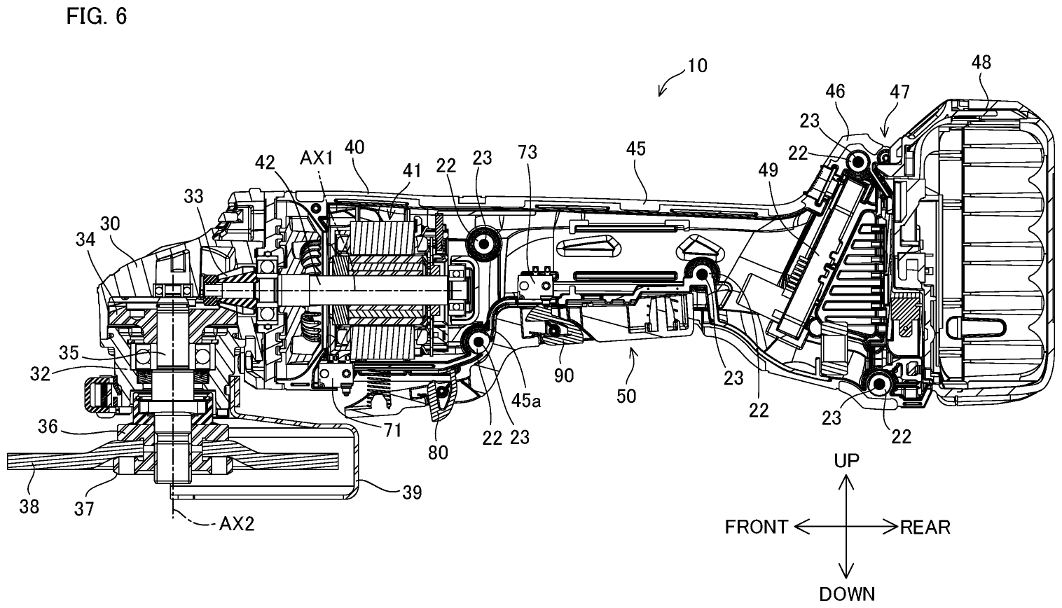

First, a first embodiment of the present invention will be described with reference to FIGS. 1 to 11. As illustrated in FIG. 3, a grinder 10 is configured to rotationally drive a generally disk-shaped tool accessory 38 mounted on a spindle 35. The spindle 35 is rotated by a rotational driving force provided from an electric motor 41. A grinding stone, a rubber pad, a brush, a blade, and the like are prepared as the tool accessory 38 mountable on the grinder 10. A user selects the appropriate tool accessory 38 according to desired processing work and mounts it on the grinder 10. According to the grinder 10, processing work such as grinding, polishing, or cutting can be performed on a processing target material according to the type of the tool accessory 38.

In the following description, a direction in which a rotational axis AX1 of the electric motor 41 (i.e., a motor shaft 42) extends is defined to be a front-rear direction of the grinder 10. One side in the front-rear direction on which the tool accessory 38 is located is defined to be a front side, and the opposite side therefrom is defined to be a rear side. The front-rear direction of the grinder 10 can also be defined as a longitudinal direction of the grinder 10. Further, a direction in which a rotational axis AX2 of the spindle 35 (i.e., a rotational axis of the tool accessory 38) extends is defined to be a vertical direction of the grinder 10. One side in the vertical direction on which the tool accessory 38 is located is defined to be a lower side, and the opposite side therefrom is defined to be an upper side. Further, a direction perpendicular to the vertical direction and the front-rear direction is defined to be a left-right direction of the grinder 10. A right side in the left-right direction when the front side is viewed from the rear side is defined to be a right side of the grinder 10, and the opposite side therefrom is defined to be a left side of the grinder 10.

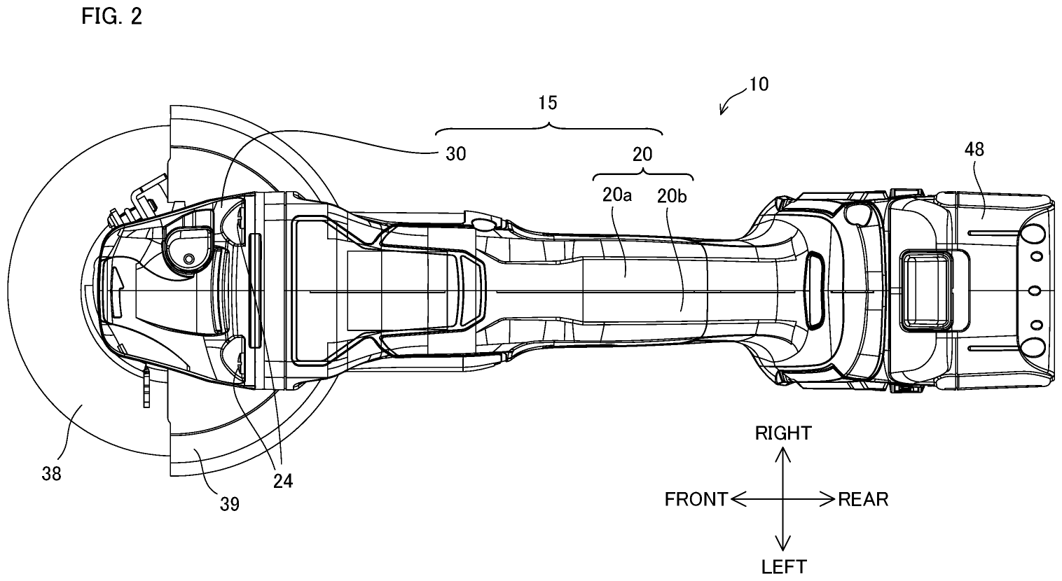

As illustrated in FIGS. 1 and 2, the grinder 10 includes a housing 15. The housing 15 includes a metal gear housing 30 and a main body housing 20 made of resin. As illustrated in FIG. 3, a power transmission mechanism for transmitting the rotational driving force of the electric motor 41 to the tool accessory 38 is contained in the gear housing 30. More specifically, a small bevel gear 33, a large bevel gear 34, and the spindle 35 are contained in the gear housing 30 as the power transmission mechanism. The small bevel bear 33 is fixed around the motor shaft 42 at the front end portion of the motor shaft 42 of the electric motor 41. The spindle 35 is supported rotatably about the rotational axis AX2 by bearings disposed so as to be vertically spaced apart from each other. The rotational axis AX2 intersects with (more specifically, intersects perpendicularly to) the rotational axis AX1 of the electric motor 41. The large bevel gear 34 is fixed around the spindle 35 on the upper side of the spindle 35, and is meshed with the small bevel gear 33. A bearing box 32 made of resin or metal, which supports the bearing rotatably supporting the spindle 35, is attached at the lower portion of the gear housing 30. The bearing box 32 has a vertically extending cylindrical shape, and a cover 39 is detachably attached on the outer periphery thereof. The cover 39 covers the rear half of the tool accessory 38.

The spindle 35 extends vertically in the gear housing 30, and extends out of the gear housing 30 on the lower side. A tool accessory holding portion, which includes an inner flange 36 and a lock nut 37, is connected to the spindle 35. More specifically, the inner flange 36 is attached around the spindle 35 at the lower end portion of the spindle 35 extending out of the gear housing 30. A male screw portion is formed on a portion of the spindle 35 which is located on the lower side of the inner flange 36, and the lock nut 37 is attached to this male screw portion. The position of the tool accessory 38 relative to the spindle 35 is fixed by interposing the tool accessory 38 between the inner flange 36 and the lock nut 37 and tightening the lock nut 37.

As illustrated in FIG. 2, the main body housing 20 is disposed behind the gear housing 30. The main body housing 20 is joined to the gear housing 30 using a plurality of screws or bolts 24 (refer to FIGS. 1 and 2). The main body housing 20 is configured to be divisible in the left-right direction. As illustrated in FIG. 3, in the present embodiment, a plurality of screw bosses 22 is formed on a right housing 20a and a left housing 20b, which are half-divided members. The main body housing 20 is formed by joining the right housing 20a and the left housing 20b to each other using screws or bolts 23 inserted in the screw bosses 22. The main body housing 20 includes a motor housing 40, a handle housing 45, and a rear housing 46 (refer to FIG. 1). In the present embodiment, each of the right housing 20a and the left housing 20b is an integrally molded single member. However, at least a part of them may be formed by joining a plurality of members.

As illustrated in FIGS. 1 and 3, the motor housing 40 is located adjacent to the gear housing 30 behind the gear housing 30. The motor housing 40 has a tubular shape extending in the front-rear direction. The electric motor 41 is contained in the motor housing 40. In the present embodiment, the electric motor 41 is driven by a direct current supplied from a battery 48 via a controller 49. In an alternative embodiment, the electric motor 41 may be driven by alternating-current power supplied from an AC power source. The controller 49 controls the driving of the electric motor 41 by controlling electric power supplied to the electric motor 41.

As illustrated in FIGS. 1 and 3, the handle housing 45 is located adjacent to the motor housing 40 behind the motor housing 40 (i.e., the opposite side from the accessory tool 38 in the longitudinal direction of the grinder 10). The handle housing 45 is a portion intended to be held by the user with his/her hand when the grinder 10 is in use. The handle housing 45 has a tubular shape extending in the front-rear direction. The outer circumferential length of the handle housing 45 around the front-rear direction is approximately constant. In the present embodiment, this outer circumferential length of the handle housing 45 (i.e., the diameter) is smaller than the outer circumferential length of the motor housing 40 around the front-rear direction (i.e., the diameter). Therefore, the user can easily hold the handle housing 45. However, the handle housing 45 may have an outer circumferential length similar to the motor housing 40. As viewed in the left-right direction, the upper edge of the handle housing 45 is located at approximately the same position as the upper edge of the motor housing 40. In other words, the handle housing 45 is off-centered upward from the motor housing 40. The handle housing 45 includes a connection portion 45a at the front edge thereof. The connection portion 45a is a portion that connects the motor housing 40 and the handle housing 45. The connection portion 45a has a diameter gradually increasing toward the front side.

As illustrated in FIGS. 1 and 3, the rear housing 46 is located adjacent to the handle housing 45 behind the handle housing 45. The rear housing 46 is a portion larger in outer circumference around the front-rear direction than the handle housing 45. The controller 49 is contained in the rear housing 46. A battery mount portion 47, to which the battery 48 is detachably attachable, is provided at the rear edge of the rear housing 46. The battery 48 is located at the rearmost portion of the grinder 10. When the battery 48 is mounted onto the battery mount portion 47 by slidably moving the battery 48 relative to the battery mount portion 47 from the upper side to the lower side into engagement therewith, the battery 48 is electrically connected to a terminal of the battery mount portion 47 and thus the controller 49. The controller 49 may be disposed in the handle housing 45.

As illustrated in FIGS. 1 and 3, an operation member 50 is provided below the motor housing 40 and the handle housing 45. The operation member 50 is configured to be displaceable between an initial position for stopping the electric motor 41 and a startup position for starting up the electric motor 41. The operation member 50 extends in the front-rear direction along the main body housing 20 (more specifically, along the motor housing 40 and the handle housing 45).

When the electric motor 41 is driven by the user's operating the operation member 50 from the initial position to the startup position, a rotation of the motor shaft 42 is transmitted to the spindle 35 while being slowed down via the small bevel gear 33 and the large bevel bear 34. At this time, the direction of the rotational motion is also converted from the direction around the motor shaft 42 into the direction around the rotational axis AX2 of the spindle 35. According to this power transmission mechanism, the spindle 35 is rotated around the rotational axis AX2 according to the rotation of the motor shaft 42, and, as a result thereof, the tool accessory 38 fixed by the inner flange 36 and the lock nut 37 is rotated together with the spindle 35.

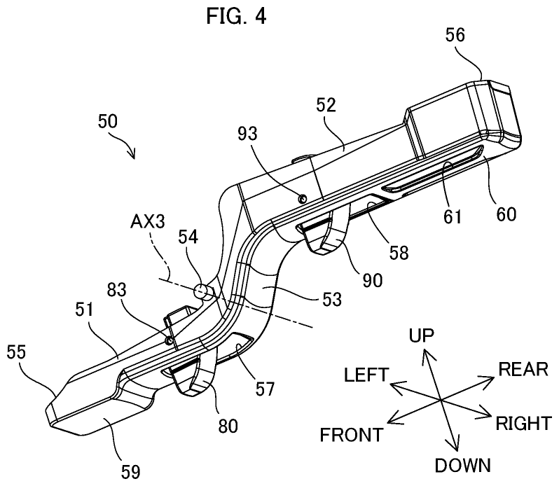

In the following description, the details of the operation member 50 and an operation for driving the electric motor 41 will be described with reference to FIGS. 4 to 11. As illustrated in FIG. 4, the operation member 50 is an integrally molded single member, and includes a first portion 51, a second portion 52, and a connection portion 53. Direction indicators in FIG. 4 indicate directions when the operation member 50 is attached to the grinder 10 and is located at the initial position. The first portion 51 is a portion extending in the front-rear direction along the motor housing 40. The second portion 52 is a portion extending in the front-rear direction along the handle housing 45. The connection portion 53 is a portion extending in a direction intersecting with the front-rear direction to connect the first portion 51 and the second portion 52. The connection portion 53 extends so as to follow the difference between the outer circumferential length of the motor housing 40 and the outer circumferential length of the handle housing 45. In other words, the connection portion 53 extends so as to approach the rotational axis AX1 of the electric motor 41 from the rear end of the first portion 51 toward the front end of the second portion 52. Each of the first portion 51, the second portion 52, and the connection portion 53 is exposed outside the main body housing 20 on the lower sides thereof (refer to FIG. 1).

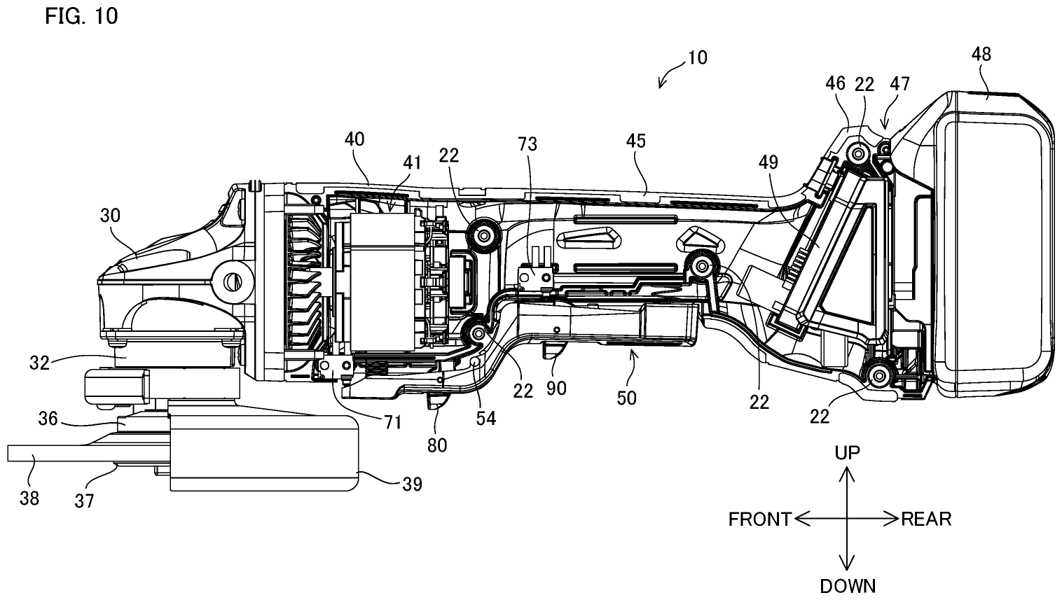

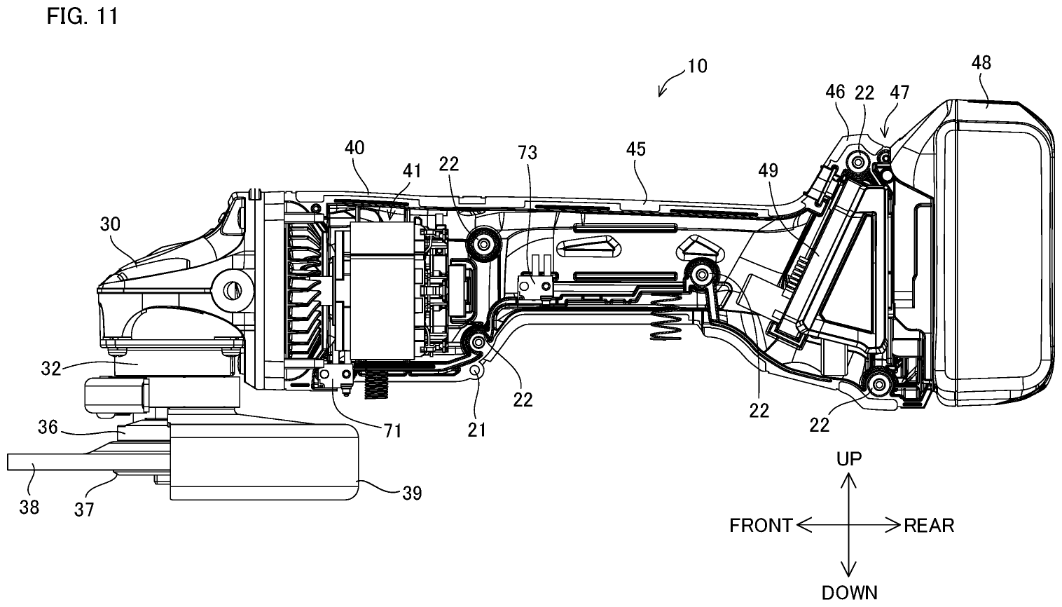

Two shaft portions 54 are provided at the connection portion 53. The two shaft portions 54 extend from the left side surface and the right side surface of the connection portion 53 outward in the left-right direction, respectively (only the shaft portion 54 extending from the left side surface can be seen in FIG. 4). Each of the shaft portions 54 is rotatably supported, at a position illustrated in FIG. 10, in a boss 21 (refer to FIG. 11) formed in the main body housing 20 so as to extend in the left-right direction. Due to this configuration, the operation member 50 is pivotal about a pivotal axis AX3 (this is a central axis of the shaft portions 54 and extends in the left-right direction). In other words, the shaft portions 54 function as a part of a hinge for pivotally moving the operation member 50. Realizing the pivotal movement of the operation member 50 in the hinged manner allows the operation member 50 to be held at a predetermined position and also allows the operation member 50 to be smoothly pivotally moved, with a simple configuration.

As illustrated in FIG. 4, the operation member 50 includes a front end portion 55 and a rear end portion 56. An elongate hole 57, which vertically extends through the lower surface of the operation member 50, is formed near the proximal end of the first portion 51 (the end portion opposite from the front end portion 55). Further, an elongate hole 58, which vertically extends through the lower surface of the operation member 50, is formed near the rear end portion 56 of the second portion 52. A first lock-off member 80 and a second lock-off member 90 extend downward from the elongate holes 57 and 58, respectively.

The first lock-off member 80 is supported by the operation member 50 via a pin 83, which extends through the first lock-off member 80 between the left surface and the right surface of the first portion 51 of the operation member 50. The first lock-off member 80 is rotatable about the pin 83. Similarly, the second lock-off member 90 is supported by the operation member 50 via a pin 93, which extends through the second lock-off member 90 between the left surface and the right surface of the second portion 52 of the operation member 50. The second lock-off member 90 is rotatable about the pin 93. Due to this configuration, the first lock-off member 80 and the second lock-off member 90 are pivotally moved integrally with the operation member 50 when the operation member 50 is pivotally moved. The first lock-off member 80 is disposed on one side in the longitudinal direction (more specifically, the front side) with respect to the pivotal axis AX3, and the second lock-off member 90 is disposed on the other side in the longitudinal direction (more specifically, the rear side) with respect to the pivotal axis AX3.

As illustrated in FIG. 4, the operation member 50 includes a first end portion-side region 59 and a second end portion-side region 60. The first end portion-side region 59 is a region containing the front end portion 55 and located opposite of the first lock-off member 80 from the pivotal axis AX3 in the front-rear direction. The second end portion-side region 60 is a region containing the rear end portion 56 and located opposite of the second lock-off member 90 from the pivotal axis AX3 in the front-rear direction.

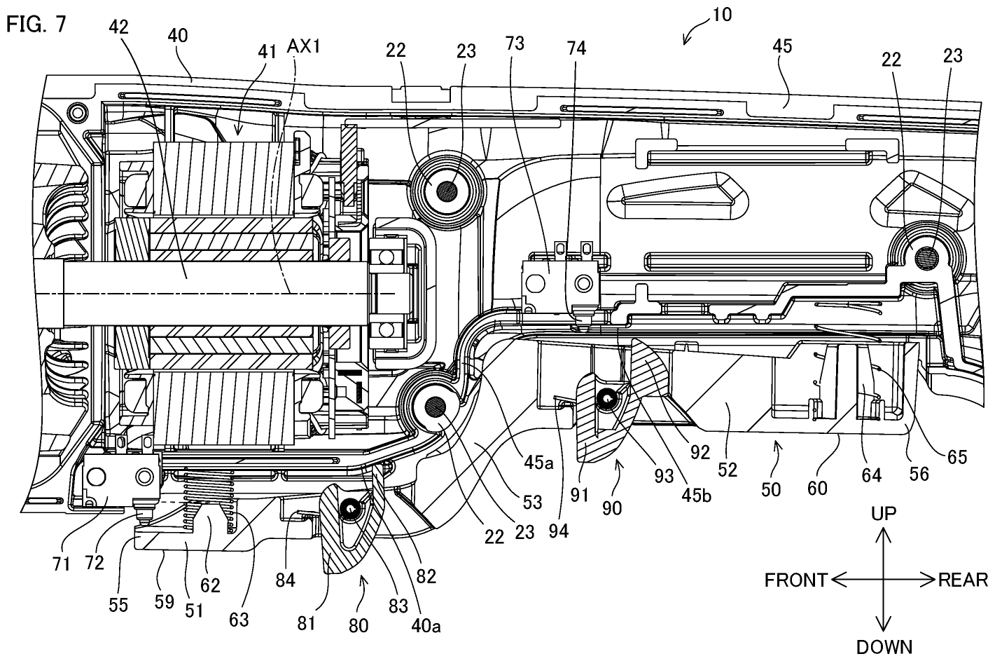

As illustrated in FIG. 7, the operation member 50 further includes spring seats 62 and 64. The spring seat 62 is located on the front side with respect to the shaft portions 54 in the longitudinal direction (more specifically, between the first lock-off member 80 and the front end portion 55 of the operation member 50). The spring seat 64 is located on the rear side with respect to the shaft portions 54 in the longitudinal direction (more specifically, between the second lock-off member 90 and the rear end portion 56 of the operation member 50). A spring 63 is disposed around the spring seat 62, and a spring 65 is disposed around the spring seat 64. The spring 63 is disposed between the lower surface of the motor housing 40 and the upper surface of the first portion 51 of the operation member 50, and biases the first portion 51 downward. In other words, the spring 63 biases the operation member 50 in a direction for pivotally moving the operation member 50 in the counterclockwise direction. The spring 65 is disposed between the lower surface of the handle housing 45 and the upper surface of the second portion 52 of the operation member 50, and biases the second portion 52 downward. In other words, the spring 65 biases the operation member 50 in a direction for pivotally moving the operation member 50 in the clockwise direction. Due to the establishment of balance between the biasing force of the spring 63 and the biasing force of the spring 65, the operation member 50 is held at the initial position illustrated in FIG. 7 (i.e., the position for stopping the electric motor 41).

The operation member 50 at the initial position is pivotal about the pivotal axis AX3 in the clockwise direction when the user performs a grip operation on the first portion 51 extending along the motor housing 40, and is pivotal about the pivotal axis AX3 (i.e., the pivotal center) in the counterclockwise direction when the user performs a grip operation on the second portion 52 extending along the handle housing 45.

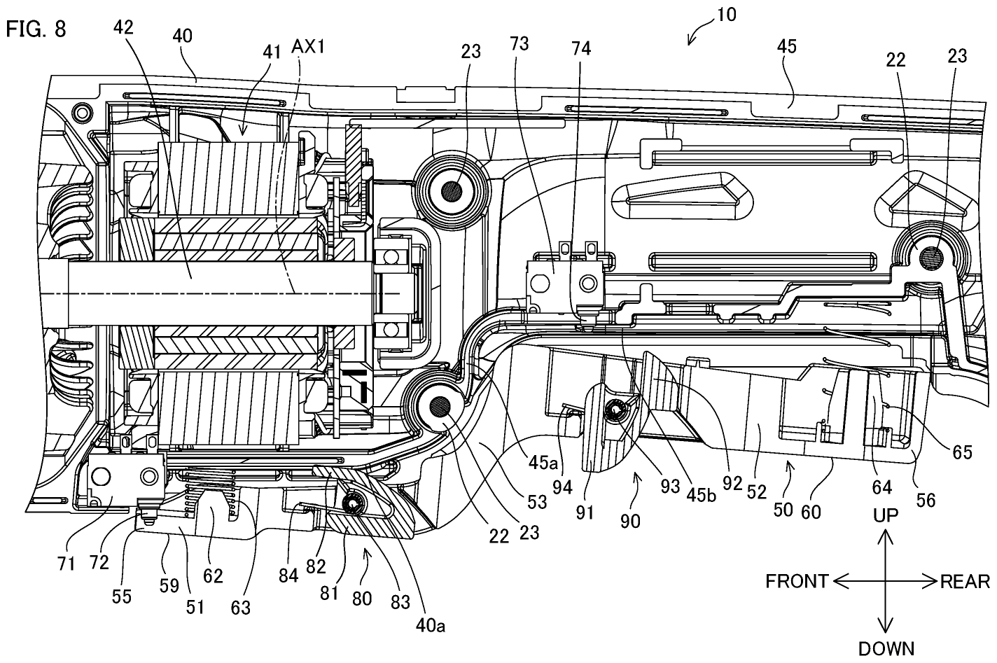

However, to prevent the operation member 50 from being moved pivotally and thus the electric motor 41 from being driven contrary to the user's intention due to the user's accidental touch on the operation member 50, the first lock-off member 80 and the second lock-off member 90 are attached to the operation member 50 as described above. The first lock-off member 80 is displaceable between a first blocking position (refer to FIG. 7), at which the first lock-off member 80 blocks the operation member 50 from being moved pivotally in the clockwise direction, and a first permission position (refer to FIG. 8), at which the first lock-off member 80 permits the operation member 50 to be moved pivotally in the clockwise direction. More specifically, as illustrated in FIG. 7, the first lock-off member 80 includes an operation portion 81 and an engagement portion 82. The operation portion 81 protrudes downward beyond the first portion 51 at the first blocking position illustrated in FIG. 7. The engagement portion 82 extends upward on the rear side of the first lock-off member 80. A torsion spring 84 is wound around the pin 83 supporting the first lock-off member 80. One end of the torsion spring 84 is engaged with the first lock-off member 80, and the other end is engaged with the operation member 50. Due to this arrangement, the torsion spring 84 biases the first lock-off member 80 toward the first blocking position illustrated in FIG. 7 (i.e., in the clockwise direction).

When the first lock-off member 80 is located at the first blocking position illustrated in FIG. 7, the operation member 50 starts to be moved pivotally about the pivotal axis AX3 (i.e., the central axis of the shaft portions 54) in the clockwise direction when the user performs the grip operation on the first portion 51 of the operation member 50. At this time, the first lock-off member 80 is also moved pivotally together with the operation member 50, and therefore the engagement portion 82 of the first lock-off member 80 is soon brought into abutment with a bottom surface 40a of the motor housing 40. Therefore, the operation member 50 can be little moved pivotally. On the other hand, when the user applies a force rearward while hooking his/her finger on the front side of the operation portion 81 of the first lock-off member 80, the first lock-off member 80 is rotated by approximately 90 degrees in the counterclockwise direction against the biasing force of the torsion spring 84 and is displaced to the first permission position as illustrated in FIG. 8. According to this displacement, the engagement portion 82 is oriented so as to extend frontward. When the user performs the grip operation on the first portion 51 of the operation member 50 in this state, the operation member 50 can be moved pivotally in the clockwise direction against the biasing force of the spring 63 because the engagement portion 82 is kept out of abutment with the bottom surface 40a.

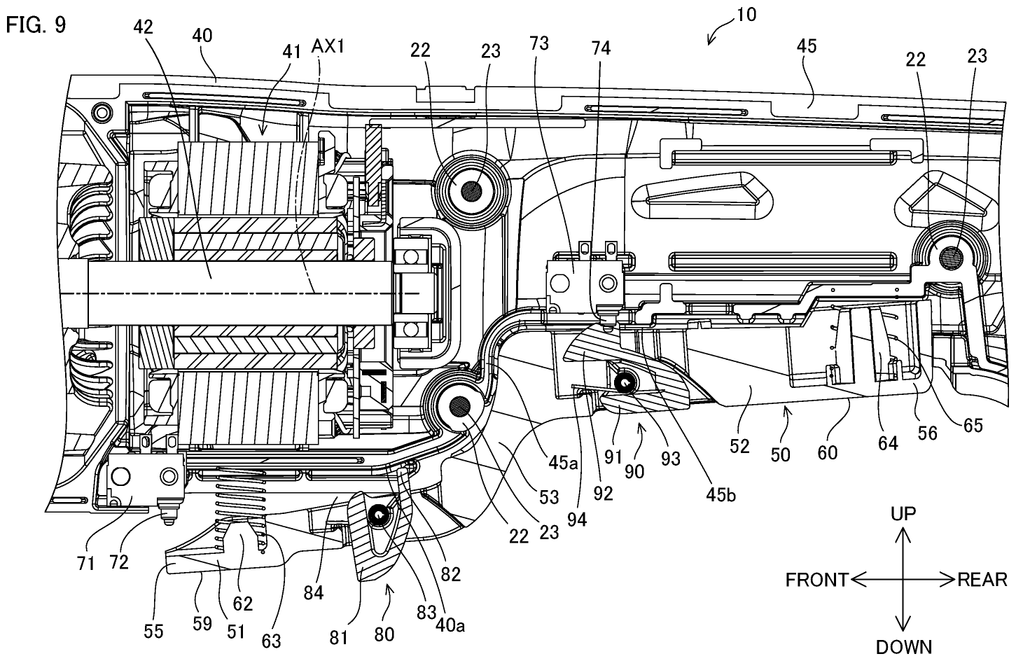

The second lock-off member 90 is displaceable between a second blocking position (refer to FIG. 7), at which the second lock-off member 90 blocks the operation member 50 from being moved pivotally in the counterclockwise direction, and a second permission position (refer to FIG. 9), at which the second lock-off member 90 permits the operation member 50 to be moved pivotally in the counterclockwise direction. More specifically, as illustrated in FIG. 7, the second lock-off member 90 includes an operation portion 91 and an engagement portion 92. The operation portion 91 protrudes downward beyond the second portion 52 at the second blocking position illustrated in FIG. 7. The engagement portion 92 extends upward on the rear side of the second lock-off member 90. A torsion spring 94 is wound around the pin 93 supporting the second lock-off member 90. One end of the torsion spring 94 is engaged with the second lock-off member 90, and the other end is engaged with the operation member 50. Due to this arrangement, the torsion spring 94 biases the second lock-off member 90 toward the second blocking position illustrated in FIG. 7 (i.e., in the clockwise direction).

When the second lock-off member 90 is located at the second blocking position illustrated in FIG. 7, the operation member 50 starts to be moved pivotally about the pivotal axis AX3 (i.e., the central axis of the shaft portions 54) in the counterclockwise direction when the user performs the grip operation on the second portion 52 of the operation member 50. At this time, the second lock-off member 90 is also moved pivotally together with the operation member 50, and therefore the engagement portion 92 of the second lock-off member 90 is soon brought into abutment with a bottom surface 45b of the handle housing 45. Therefore, the operation member 50 can be little moved pivotally. On the other hand, when the user applies a force rearward while hooking his/her finger on the front side of the operation portion 91 of the second lock-off member 90, the second lock-off member 90 is rotated by approximately 90 degrees against the biasing force of the torsion spring 94 and is displaced to the second permission position as illustrated in FIG. 9. According to this displacement, the engagement portion 92 is oriented so as to extend frontward. When the user performs the grip operation on the second portion 52 of the operation member 50 in this state, the operation member 50 can be moved pivotally in the counterclockwise direction against the biasing force of the spring 65 because the engagement portion 92 is kept out of abutment with the bottom surface 45b.

To detect such a pivotal motion of the operation member 50, the grinder 10 includes a first switch 71 and a second switch 73. In the present embodiment, each of the first switch 71 and the second switch 73 is a microswitch. According to the microswitch, the size of the grinder 10 can be reduced. In addition, a pressing load necessary to switch the microswitch from an OFF state to an ON state is lower compared to a switch used in the conventional grinder, and therefore the microswitch allows the user to perform the grip operation on the operation member 50 with a further weak force. In other words, the operability is not impaired compared to the conventional grinder, in which the pivotal axis is located at one end of the operation member and the distance between the other end of the operation member and the pivotal axis is comparatively long. Further, since requiring a low pressing load, the microswitch allows the distance to reduce between the position at which the operation member 50 is operated and the pivotal axis AX3. However, the first switch 71 and the second switch 73 may be any other type of switch capable of detecting the pivotal movement of the operation member 50 (for example, a limit switch).

In the present embodiment, the first switch 71 is disposed on the front side with respect to the shaft portions 54 (i.e., the pivotal axis AX3), and the second switch 73 is disposed on the rear side with respect to the shaft portions 54. The first switch 71 includes an actuator portion 72, and is disposed at the bottom portion in the motor housing 40 in such a manner that the actuator portion 72 protrudes downward. The second switch 73 includes an actuator portion 74, and is disposed at the bottom portion in the handle housing 45 in such a manner that the actuator portion 74 protrudes downward. The actuator portion 74 extends downward from a hole formed on the bottom surface 45b of the handle housing 45.

As illustrated in FIG. 8, when the user displaces the first lock-off member 80 from the first blocking position to the first permission position and further performs the grip operation on the first portion 51 of the operation member 50 in this state, the operation member 50 is moved pivotally about the pivotal axis AX3 (i.e., the central axis of the shaft portions 54) in the clockwise direction. Then, when this pivotal angle reaches a predetermined amount, the actuator portion 72 of the first switch 71 is pressed by the front end portion 55 of the operation member 50. As a result, the ON/OFF state of a contact inside the first switch 71 is switched, and the first switch 71 detects the clockwise pivotal movement of the operation member 50. The first switch 71 is electrically connected to the controller 49. When the detection of the clockwise pivotal movement of the operation member 50 by the first switch 71 is detected by the controller 49, the controller 49 supplies electric power from the battery 48 to the electric motor 41, thereby driving the electric motor 41. When the user releases his/her finger from the operation member 50, the operation member 50 is returned to the initial position under the biasing force of the spring 63, and the first lock-off member 80 is also moved pivotally together with the operation member 50 and is also returned to the first blocking position under the biasing force of the torsion spring 84 (refer to FIG. 7). When the ON/OFF state of the contact inside the first switch 71 is also returned to its original state as a result thereof, the controller 49 detects that and stops supplying the electric power to the electric motor 41, thereby stopping the electric motor 41.

Further, as illustrated in FIG. 9, when the user displaces the second lock-off member 90 from the second blocking position to the second permission position and further performs the grip operation on the second portion 52 of the operation member 50 in this state, the operation member 50 is moved pivotally about the pivotal axis AX3 (i.e., the central axis of the shaft portions 54) in the counterclockwise direction. Then, when this pivotal angle reaches a predetermined amount, the actuator portion 74 of the second switch 73 is pressed by the engagement portion 92 of the second lock-off member 90. The portion of the engagement portion 92 that is in contact with the actuator portion 74 is formed in a circular arc shape, and therefore the engagement portion 92 can smoothly press the actuator portion 74. The ON/OFF state of a contact inside the second switch 73 is switched due to the actuator portion 74 being pressed, and the second switch 73 detects the counterclockwise pivotal movement of the operation member 50. The second switch 73 is electrically connected to the controller 49. When the detection of the counterclockwise pivotal movement of the operation member 50 by the second switch 73 is detected by the controller 49, the controller 49 supplies electric power from the battery 48 to the electric motor 41, thereby driving the electric motor 41. The electric motor 41 is rotated at this time in the same direction as when the clockwise pivotal movement of the operation member 50 is detected by the first switch 71. When the user releases his/her finger from the operation member 50, the operation member 50 is returned to the initial position under the biasing force of the spring 65, and the second lock-off member 90 is also moved pivotally together with the operation member 50 and is also returned to the second blocking position under the biasing force of the torsion spring 94 (refer to FIG. 7). When the ON/OFF state of the contact inside the second switch 73 is also returned to its original state as a result thereof, the controller 49 detects that and stops supplying the electric power to the electric motor 41, thereby stopping the electric motor 41. In this manner, according to the grinder 10, the electric motor 41 is rotated in the same direction both when the user pivotally moves the operation member 50 in the clockwise direction by performing the grip operation on the first portion 51 of the operation member 50 on the front side with respect to the pivotal axis AX3 and when the user pivotally moves the operation member 50 in the counterclockwise direction by performing the grip operation on the second portion 52 on the rear side with respect to the pivotal axis AX3.

According to the above-described grinder 10, the operation member 50 is exposed outside the main body housing 20 on both the front side and the rear side with respect to the pivotal axis AX3, and the user can perform the grip operation on the operation member 50 using desired one of the first portion 51 on the front side with respect to the pivotal axis AX3 and the second portion 52 on the rear side with respect to the pivotal axis AX3. Since the first portion 51 extends in the front-rear direction along the motor housing 40 and the second portion 52 extends in the front-rear direction along the handle housing 45, the user can perform the grip operation on the operation member 50 both when holding the motor housing 40 and when holding the handle housing 45. Then, since the pivotal axis AX3 is located between the front end portion 55 and the rear end portion 56 of the operation member 50, a distance can be secured to some extent both between the pivotal axis AX3 and the front end of the first portion 51 (i.e., the front end portion 55) and between the pivotal axis AX3 and the rear end of the second portion 52 (i.e., the rear end portion 56). Therefore, a distance between the grip position and the pivotal axis AX3 and thus a stroke amount of the operation member 50 at the grip position can be secured to some extent both when the user performs the grip operation on the first portion 51 and when the user performs the grip operation on the second portion 52 (i.e., both when the user holds the motor housing 40 and when the user holds the handle housing 45). Therefore, the operability of the operation member 50 is improved. That is, the excellent operability of the operation member 50 can b e acquired both when the user holds the motor housing 40 and when the user holds the handle housing 45. In other words, the excellent operability of the operation member 50 can be acquired both on the front side and the rear side of the grinder 10.

Further, according to the grinder 10, the first switch 71 is disposed on the front side with respect to the pivotal axis AX3 and the second switch 73 is disposed on the rear side with respect to the pivotal axis AX3, and therefore a layout of the grinder 10 capable of preventing or minimizing a size increase can be easily set compared to when the two switches are collectively placed on one side with respect to the pivotal axis AX3.

Further, according to the grinder 10, the single operation member 50 is configured to be pivotal in the clockwise direction or the counterclockwise direction according to the position gripped by the user. Therefore, the number of parts reduces and the apparatus can be simply configured compared to when equivalent functions are realized using a plurality of operation members. Further, this configuration allows the user to easily understand the operation method.

Further, according to the grinder 10, the pivotal axis AX3 is located at the connection portion 53 of the operation member 50, which extends in the direction intersecting with the front-rear direction to connect the first portion 51 and the second portion 52 (i.e., the portion where the outer circumferential length around the front-rear direction gradually changes). In other words, the pivotal center of the operation member 50 is located at the connection portion 45a connecting the motor housing 40 and the handle housing 45. Generally, the user selectively holds the motor housing 40 or the handle housing 45 according to his/her own preference or the type of the work, but the portion around the boundary between the motor housing 40 and the handle housing 45 is rarely held by the user compared to the other portions. Therefore, according to the arrangement of the pivotal axis AX3 (the pivotal center) set in the above-described manner, the distance between the grip position and the pivotal axis AX3 (i.e., the stroke amount of the operation member 50 at the grip position) can be further reliably acquired both when the user performs the grip operation on the first portion 51 and when the user performs the grip operation on the second portion 52.

Further, according to the grinder 10, the stroke amount facilitating the switch operation (i.e., the protrusion amount from the main body housing 20 in the pivotal direction of the operation member 50) is secured at both the first portion 51 and the second portion 52, and therefore the user can easily operate the operation member 50 both when performing the grip operation on the first portion 51 and when performing the grip operation on the second portion 52. Further, since the pivotal axis AX3 is disposed between the front end portion 55 and the rear end portion 56, the appropriate stroke amount of the operation member 50 can be secured at the grip position while the operation member 50 is prevented from protruding from the product by an excessive amount. More specifically, in the conventional grinder having the pivotal axis located on one end of the operation member in the longitudinal direction, it has been difficult to secure a protrusion amount (i.e., a stroke amount) facilitating the operation throughout the entire operation member. More specifically, the conventional grinder has raised such a problem that the protrusion amount excessively reduces on the side close to the pivotal axis if an appropriate protrusion amount facilitating the operation is set on the side distant from the pivotal axis, while the protrusion amount excessively increases on the side distant from the pivotal axis if an appropriate protrusion amount facilitating the operation is set on the side close to the pivotal axis. On the other hand, the grinder 10 according to the present embodiment allows the appropriate protrusion amount to be secured on both the front side and the rear side of the operation member 50 due to the placement of the pivotal axis AX3 between the front end portion 55 and the rear end portion 56. In other words, excellent operability can be acquired on both the front side and rear side of the operation member 50.

Further, since the pivotal axis AX3 is disposed between the first portion 51 and the second portion 52, the distance between the grip position and the pivotal axis AX3 can be appropriately secured with respect to both the first portion 51 and the second portion 52, and therefore the operation member 50 is prevented from becoming hard to press because requiring a too high pressing load. Further, the pressing load is appropriately set with respect to both the first portion 51 and the second portion 52. Disposing the pivotal axis at the end portion of the operation member involves such a problem that setting an appropriate pressing load at a position distant from the pivotal axis leads to an increase in the pressing load and makes it hard to press the operation member at a position close to the pivotal axis, but, according to the grinder 10, the operation member 50 can be operated with an appropriate pressing load with respect to both the first portion 51 and the second portion 52.

Further, according to the grinder 10, the first switch 71 is disposed in such a manner that the actuator portion 72 is pressed by the front end portion 55 of the operation member 50 when the operation member 50 is moved pivotally in the clockwise direction. Therefore, a long distance can be secured between the portion of the operation member 50 that presses the actuator portion 72, and the pivotal axis AX3. The displacement amount of the operation member 50 due to the pivotal movement increases at a portion farther away from the pivotal axis AX3. Therefore, a greater displacement amount can be necessitated to cause the operation member 50 to press the actuator portion 72 to bring the first switch 71 into the ON state. As a result, an erroneous operation with respect to the first switch 71 is less likely to occur. For example, when an external force is applied to the operation member 50 and the operation member 50 is slightly deflected, the operation member 50 is prevented from bringing the first switch 71 into the ON state by accidentally pressing the actuator portion 72. Alternatively, the required precision of the dimension or assembling of the grinder 10 can be eased. In an alternative embodiment, the second switch 73 may be disposed at a position where the actuator portion 74 is pressed by the rear end portion 56 of the operation member 50 when the operation member 50 is moved pivotally in the counterclockwise direction instead of the above-described embodiment in which the actuator portion 74 is pressed by the engagement portion 92 of the second lock-off member 90 when the operation member 50 is moved pivotally in the counterclockwise direction. This arrangement of the second switch 73 can achieve similar advantageous effects to the arrangement of the first switch 71.

Further, according to the grinder 10, the second switch 73 is disposed at the position where the actuator portion 74 is pressed by the engagement portion 92 of the second lock-off member 90 when the operation member 50 is moved pivotally in the counterclockwise direction. Employing such a configuration can prevent a part of the operation member 50 or the second lock-off member 90 from pressing the actuator portion 74 contrary to the intention even if, when the second lock-off member 90 is located at the second blocking position, an external force is applied to the operation member 50 and the operation member 50 is deflected with a pivot point placed at the contact portion between the engagement portion 92 of the second lock-off member 90 and the bottom surface 45b of the handle housing 45. This advantageous effect can also be achieved by setting a relatively short distance between the second switch 73 and the second lock-off member 90 in the case where the grinder 10 is configured in such a manner that the actuator portion 74 is pressed by a part of the operation member 50 when the operation member 50 is moved pivotally in the counterclockwise direction. For example, both the second switch 73 and the second lock-off member 90 may be disposed between the pivotal axis AX3 and the rear end portion 56 at a position closer to the rear end portion 56 in the front-rear direction. Similarly, both the first switch 71 and the first lock-off member 80 may be disposed between the pivotal axis AX3 and the front end portion 55 at a position closer to the front end portion 55. Alternatively, the second switch 73 may be disposed between the second lock-off member 90 and the rear end portion 56 at a position closer to the second lock-off member 90 in the front-rear direction. Such a layout can place the second switch 73 and the second lock-off member 90 closer to each other although the distance between the second switch 73 and the pivotal axis AX3 reduces. Similarly, the first switch 71 may be disposed between the first lock-off member 80 and the front end portion 55 at a position closer to the first lock-off member 80 in the front-rear direction.

Moreover, since the second switch 73 is disposed at the position where it is pressed by the second lock-off member 90 when the operation member 50 is moved pivotally in the counterclockwise direction, unintended actuation of the electric motor 41 can be prevented even when the second lock-off member 90 is broken. In an alternative embodiment, instead of or in addition to this configuration, the first switch 71 may be disposed at a position where it is pressed by the first lock-off member 80 when the operation member 50 is moved pivotally in the clockwise direction.

In an alternative embodiment, the first switch 71 and the first lock-off member 80 may be disposed between the pivotal axis AX3 and the front end portion 55 at a position closer to the front end portion 55 in the front-rear direction. According to such an arrangement, the grinder 10 can compatibly attain both the characteristic that the distance between the first switch 71 and the pivotal axis AX3 is long and the characteristic that the distance between the first switch 71 and the first lock-off member 80 is short. Therefore, the above-described advantageous effects of these characteristics can be maximized. In other words, an erroneous operation of the first switch 71 can be further prevented or reduced and the required precision of the dimension or the assembling of the grinder 10 can be further eased. Similarly, the second switch 73 and the second lock-off member 90 may be disposed between the pivotal axis AX3 and the rear end portion 56 at a position closer to the rear end portion 56. By employing such an arrangement, the grinder 10 can compatibly attain both the characteristic that the distance between the second switch 73 and the pivotal axis AX3 is long and the characteristic that the distance between the second switch 73 and the second lock-off member 90 is short. Therefore, the above-described advantageous effects of these characteristics can be maximized.

In a further alternative embodiment, the operation member 50 may be configured to facilitate a grip operation near the front end portion 55 or the rear end portion 56. As such a configuration, for example, the first lock-off member 80 may be disposed between the front end portion 55 and the pivotal axis AX3 at a position closer to the front end portion 55 in the front-rear direction, and the second lock-off member 90 may be disposed between the pivotal axis AX3 and the rear end portion 56 at a position closer to the rear end portion 56 in the front-rear direction. Normally, the user rotates the first lock-off member 80 or the second lock-off member 90 with some finger of one of his/her hands and performs the grip operation on the operation member 50 with this hand, and therefore the portion subjected to the grip operation is highly likely to be a portion near the first lock-off member 80 or the second lock-off member 90. In the above-described illustrated embodiment, for example, the user is expected to perform the grip operation on the first end portion-side region 59 with his/her index finger and middle finger while rotating the first lock-off member 80 with his/her ring finger or little finger when performing the grip operation on the first portion 51. Further, in the above-described illustrated embodiment, for example, the user is expected to perform the grip operation on the second end portion-side region 60 with his/her middle finger and ring finger while rotating the second lock-off member 90 with his/her index finger when performing the grip operation on the second portion 52. Therefore, disposing the first lock-off member 80 at a position closer to the front end portion 55 as described above makes it easier for the user to perform the grip operation around the front end portion 55, and disposing the second lock-off member 90 at a position closer to the rear end portion 56 as described above makes it easier for the user to grip around the rear end portion 56. According to such an arrangement, a further long distance can be secured between the pivotal axis AX3 and the grip portion. Therefore, the grinder 10 can reduce the user's grip load necessary to bring the first switch 71 or the second switch 73 into the ON state according to the principle of leverage, thereby improving the operability.

In a further alternative embodiment, the first portion 51 located on the front side with respect to the pivotal axis AX3 may be shaped in such a manner that the protrusion amount of the first portion 51 from the motor housing 40 (i.e., the downward protruding amount) is maximized at the position of the front end portion 55. The second portion 52 may be shaped in such a manner that the protrusion amount of the second portion 52 from the handle housing 45 is maximized at the position of the rear end portion 56. According to such an embodiment, the orientation of the exposed portion of the operation member 50 when the user grips the operation member 50 becomes closer to the horizontal direction both when the user performs the grip operation on the first portion 51 and when the user performs the grip operation on the second portion 52. This means that the user continuously drives the motor 41 while holding the operation member 50 in the state that the orientation of the exposed portion of the operation member 50 has become closer to the horizontal direction. As a result, the user's operational feeling in a state of firmly gripping the operation member 50 can be improved.

In a further alternative embodiment, the first portion 51 may be shaped in such a manner that the protrusion amount of the first portion 51 from the motor housing 40 gradually increases toward the front side (i.e., as the distance from the pivotal axis AX3 increases). Similarly, the second portion 52 may be shaped in such a manner that the protrusion amount of the second portion 52 from the handle housing 45 gradually increases toward the rear side (i.e., as the distance from the pivotal axis AX3 increases). According to this embodiment, the orientation of the exposed portion of the operation member 50 becomes further closer to the horizontal direction when the user grips the operation member 50. In a further alternative embodiment, the lower surface of the first portion 51 (i.e., an operation target surface that should be subjected to the grip operation by the user) may extend horizontally (i.e., in the front-rear direction and the left-right direction) when the first switch 71 is in the ON state. Further, the lower surface of the second portion 52 (i.e., an operation target surface that should be subjected to the grip operation by the user) may extend horizontally when the second switch 73 is in the ON state. With such a configuration, the user's operational feeling can be further improved.

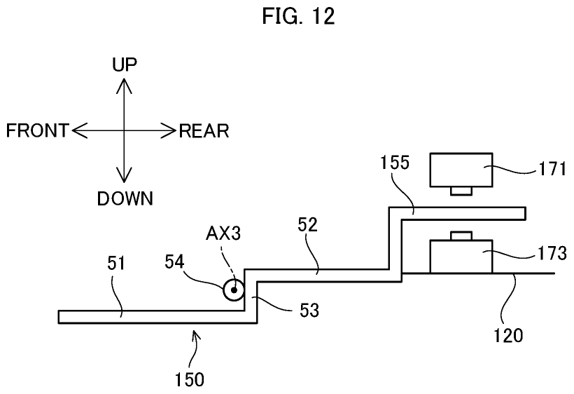

In the following description, a second embodiment of the present invention will be described with reference to FIG. 12, focusing on only differences from the first embodiment. In FIG. 12, components similar to the first embodiment are identified by the same reference numerals as the reference numerals used in the first embodiment. An operation member 150 according to the second embodiment includes a third portion 155 behind the second portion 52. The third portion 155 extends upward from the rear end of the second portion 52, and, after that, is bent and extends rearward to be contained inside a main body housing 120. A first switch 171 is disposed above the third portion 155, and a second switch 173 is disposed below the third portion 155.

According to this configuration, the third portion 155 presses the first switch 171 when the operation member 150 is moved pivotally in the counterclockwise direction, and presses the second switch 173 when the operation member 150 is moved pivotally in the clockwise direction. As clearly seen from this configuration, the two switches may be collectively disposed on one side with respect to the pivotal axis AX3 in the front-rear direction.

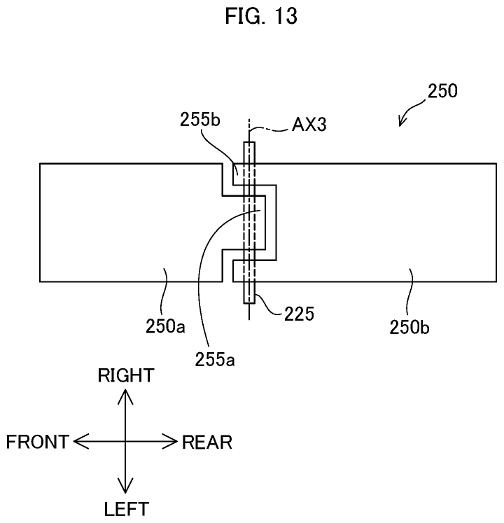

In the following description, a third embodiment of the present invention will be described with reference to FIG. 13, focusing on only differences from the first embodiment. An operation member 250 according to the third embodiment includes a first operation member 250a and a second operation member 250b. The first operation member 250a extends in the front-rear direction along the motor housing 40 (not illustrated in FIG. 13), and the second operation member 250b extends in the front-rear direction along the handle housing 45 (not illustrated in FIG. 13). The first operation member 250a includes a boss 255a at the rear end thereof, and the second operation member 250b includes a boss 255b at the front end thereof. The bosses 255a and 255b are coupled with a shaft portion 225 formed on the main body housing 20 in a hinged manner.

When the user performs the grip operation on the first operation member 250a, the first operation member 250a is moved pivotally about the pivotal axis AX3 (this is the central axis of the shaft portion 225 and extends in the left-right direction) in the clockwise direction. On the other hand, when the user performs the grip operation on the second operation member 250b, the second operation member 250b is moved pivotally about the pivotal axis AX3 in the counterclockwise direction. In this manner, the two operation members 250a and 250b pivotal about the common pivotal axis AX3 in opposite directions from each other may be used.

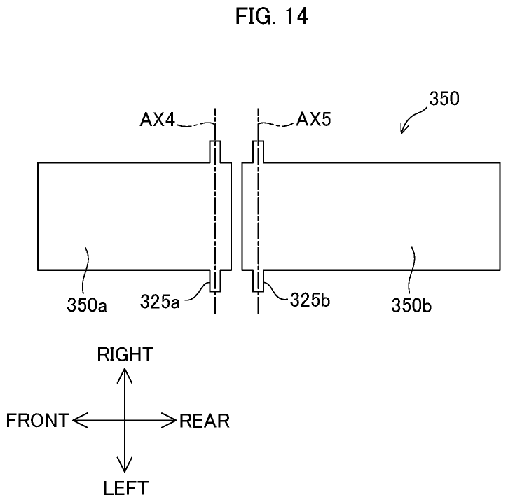

In the following description, a fourth embodiment of the present invention will be described with reference to FIG. 14, focusing on only differences from the first embodiment. An operation member 350 according to the fourth embodiment includes a first operation member 350a and a second operation member 350b. The first operation member 350a extends in the front-rear direction along the motor housing 40 (not illustrated in FIG. 14), and the second operation member 350b extends in the front-rear direction along the handle housing 45 (not illustrated in FIG. 14). The first operation member 350a includes shaft portions 325a at the rear end thereof, and the second operation member 350b includes shaft portions 325b at the front end thereof. The shaft portions 325a and the shaft portions 325b are supported pivotally in two bosses formed in the main body housing 20, respectively.

When the user performs the grip operation on the first operation member 350a, the first operation member 350a is moved pivotally about a first pivotal axis AX4 (this is a central axis of the shaft portions 325a and extends in the left-right direction) in the clockwise direction. On the other hand, when the user performs the grip operation on the second operation member 350b, the second operation member 350b is moved pivotally about a second pivotal axis AX5 (this is a central axis of the shaft portions 325b and extends in the left-right direction) in the counterclockwise direction. In this manner, the two operation members 350a and 350b having the individual pivotal axes AX4 and AX5 may be used.

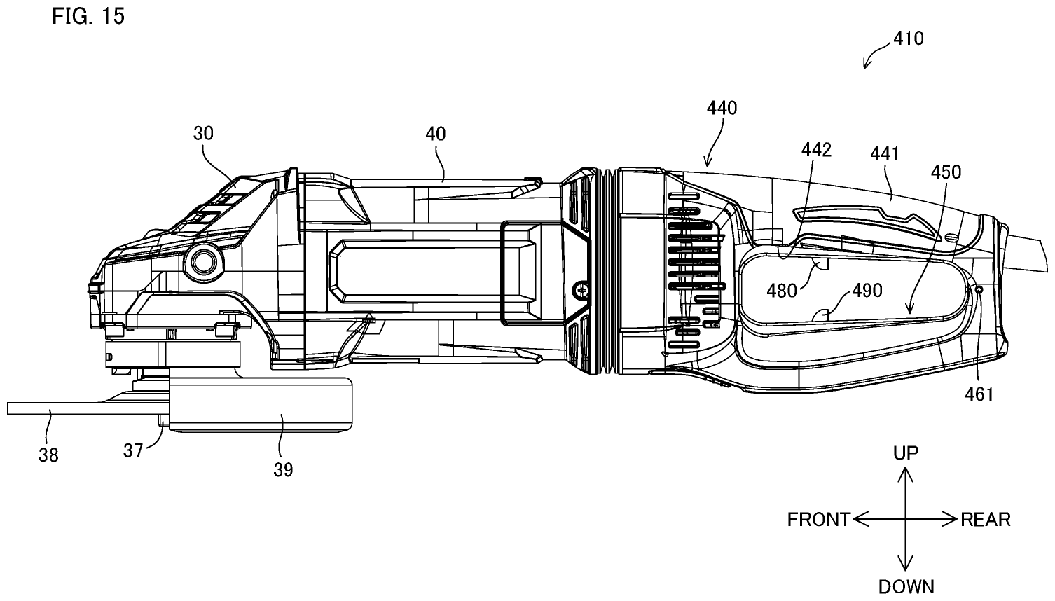

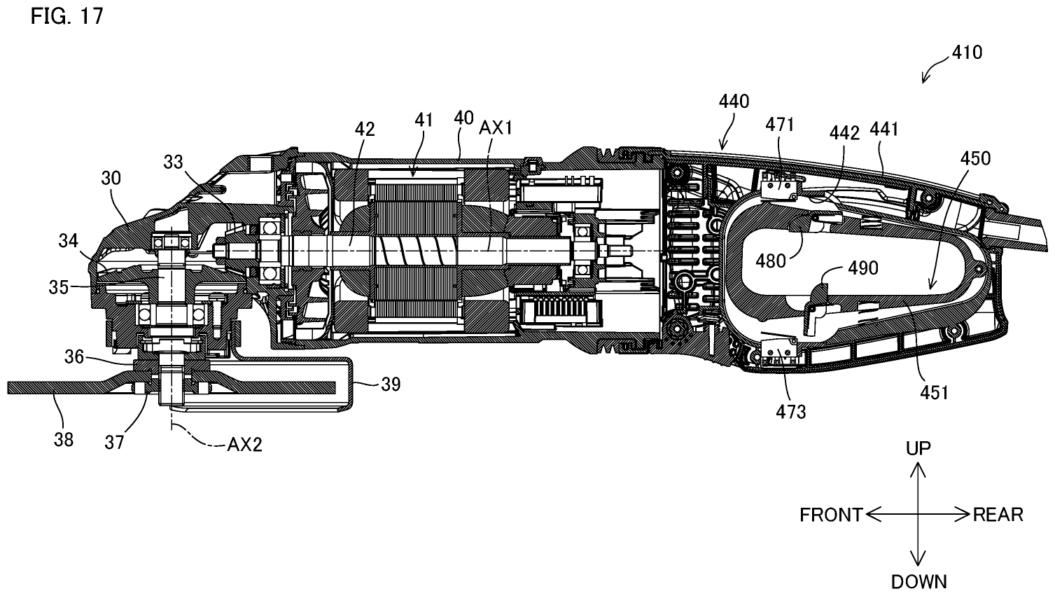

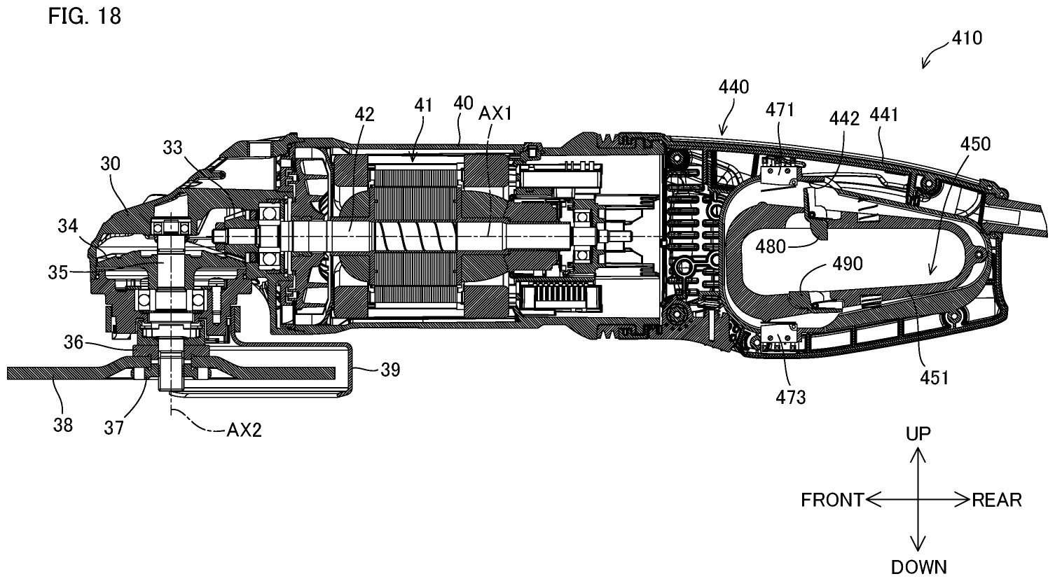

In the following description, a fifth embodiment of the present invention will be described with reference to FIGS. 15 to 20, focusing on only differences from the first embodiment. As illustrated in FIG. 15, a grinder 410 according to the fifth embodiment includes a handle housing 440 behind the motor housing 40. The handle housing 440 is a hollow member extending elongatedly in the front-rear direction. The handle housing 440 is of so-called loop-type, and includes an annular portion 441 extending elongatedly on the rear side thereof. The annular portion 441 is a portion intended to be held by the user. Further, the annular portion 441 is a portion surrounding around a through-hole 442, which extends through the handle housing 440 in the left-right direction, and has a closed annular shape. The through-hole 442 is shaped so as to have a vertical width increasing toward the front side as viewed in the left-right direction. The annular portion 441 may have an annular shape opened at the rear end thereof.

An operation member 450 is disposed inside the handle housing 440. The operation member 450 is of loop-type, and has an annular shape along the inner side of the handle housing 440 (i.e., along the outline of the through-hole 442). The operation member 450 extends in such a manner that the longitudinal direction thereof matches the front-rear direction. The inner edge portion of the operation member 450 has a generally elongated circular shape as viewed in the left-right direction. The outer edge portion of the operation member 450 is shaped so as to have a vertical width increasing toward the front side as viewed in the left-right direction. The operation member 450 is disposed in such a manner that the whole thereof is exposed outside the handle housing 440 (more specifically, the annular portion 441). The clearance between the inner edge portion of the annular portion 441 of the handle housing 440 and a main body 451 of the operation member 50 increases toward the front side. The main body 451 may have an annular shape opened at the front end thereof.

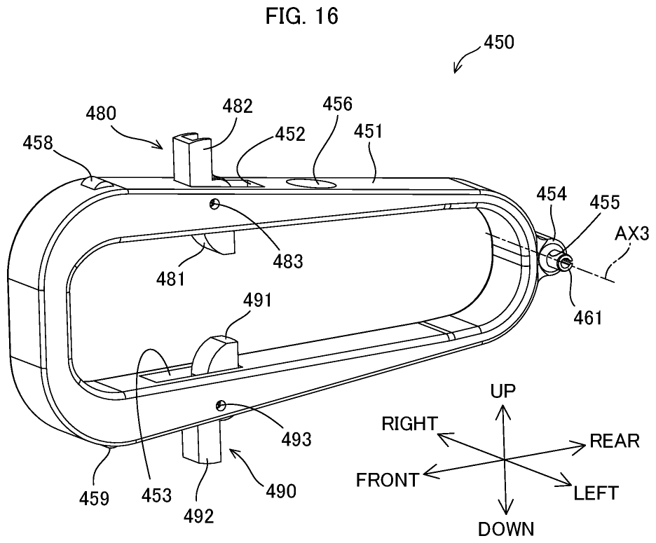

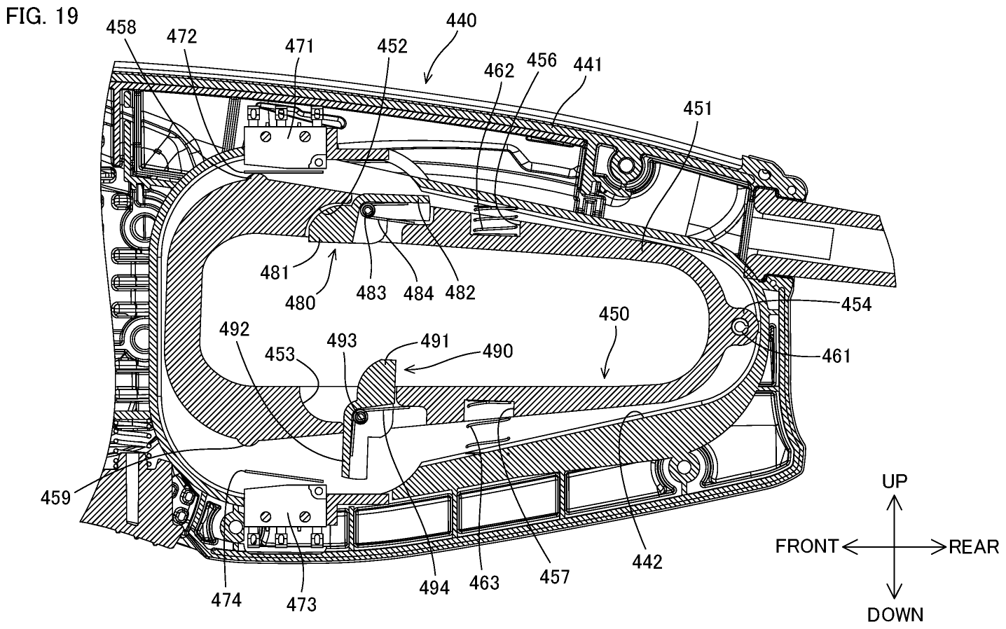

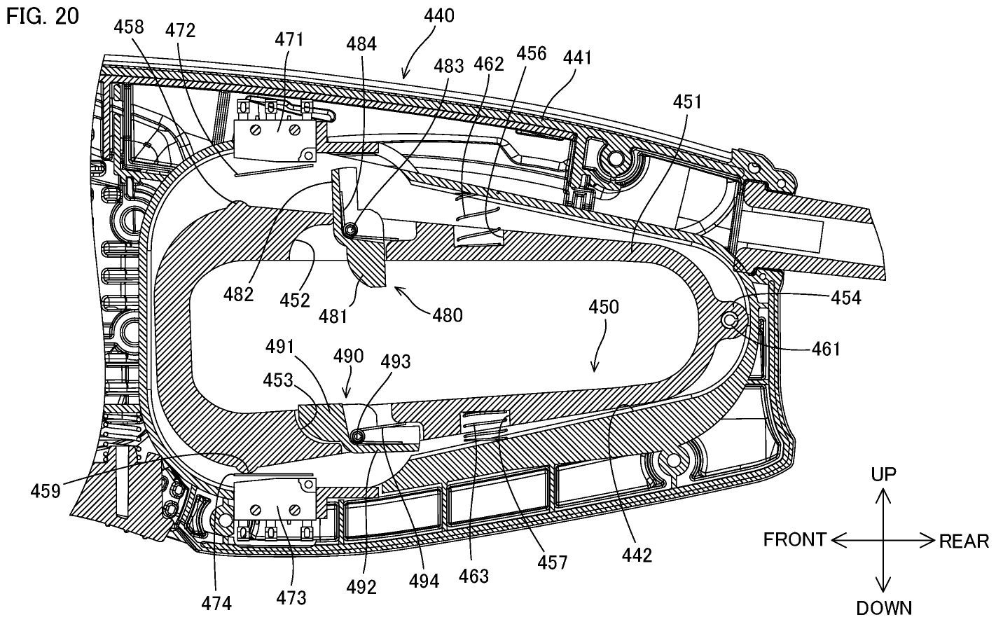

As illustrated in FIG. 16, the operation member 450 includes the main body 451 having the above-described annular shape and a pivotal axis portion 454. The pivotal axis portion 454 is disposed so as to protrude rearward from the main body 451 at the rear edge and the vertical center of the main body 451. The pivotal axis portion 454 has a circular cylindrical shape extending in the left-right direction, and a through-hole 455 extending in the left-right direction is formed inside the pivotal axis portion 454. A pin 461 is inserted in the through-hole 455 so as to extend from the pivotal axis portion 454 in both the leftward direction and the rightward direction. As illustrated in FIG. 15, the pin 461 is supported between the left surface and the right surface at the position of the rear edge of the annular portion 441. Due to such a configuration, the operation member 450 is configured to be pivotal about the pin 461 (i.e., about the pivotal axis AX3 illustrated in FIG. 16) as illustrated in FIGS. 19 and 20. Since the whole of the operation member 450 is exposed outside the handle housing 440 as described above, the operation member 450 is exposed outside the handle housing 440 on the both sides with respect to the pivotal axis AX3 (i.e., the upper side and the lower side) in the direction (the vertical direction in the present embodiment) intersecting with the front-rear direction (i.e., the longitudinal direction of the grinder 410).

As illustrated in FIGS. 19 and 20, a spring 462 is disposed in a compressed state between the upper inner edge portion of the annular portion 441 and a portion extending in the front-rear direction on the upper side of the main body 451 of the operation member 450 (hereinafter also referred to as an upper portion). The spring 462 is disposed in a bottomed hole 456 formed on the upper portion in such a manner that a horizontal movement thereof is restricted. The spring 462 is disposed at an approximately central position of the main body 451 in the front-rear direction. Due to this configuration, the spring 462 biases the operation member 450 downward.

Similarly, a spring 463 is disposed in a compressed state between the lower inner edge portion of the annular portion 441 and a portion extending in the front-rear direction on the lower side of the main body 451 (hereinafter also referred to as a lower portion). The spring 463 is disposed in a bottomed hole 457 formed on the lower portion in such a manner that a horizontal movement thereof is restricted. The spring 463 is disposed at the same position as the spring 462 in the front-rear direction. Due to this configuration, the spring 463 biases the operation member 450 upward. Due to the establishment of balance between the downward biasing force of the spring 462 and the upward biasing force of the spring 463, the operation member 450 is maintained at the vertical center of the through-hole 442 of the annular portion 441. This position is an initial position of the operation member 450 when the user does not perform the grip operation thereon.

As illustrated in FIGS. 16, 19, and 20, a protrusion 458 protruding upward is formed near the front edge of the upper portion of the main body 451. A protrusion 459 protruding downward is formed near the front edge of the lower portion of the main body 451. The protrusions 458 and 459 are located at the same position in the front-rear direction. The protrusions 458 and 459 are provided to respectively press an actuator portion 472 of a first switch 471 and an actuator portion 474 of a second switch 473 when the operation member 450 is moved pivotally.

As illustrated in FIGS. 19 and 20, the first switch 471 is attached to the annular portion 441 in such a manner that the actuator portion 472 is exposed outside the annular portion 441 on the upper side with respect to the pin 461 (the pivotal axis AX3). Further, the second switch 473 is attached to the annular portion 441 in such a manner that the actuator portion 474 is exposed outside the annular portion 441 on the lower side with respect to the pin 461 (the pivotal axis AX3). The first switch 471 and the actuator portion 472 are disposed at positions corresponding to the protrusions 458 and 459 of the operation member 450, i.e., near the front edge of the operation member 450.

As illustrated in FIG. 16, through-holes 452 and 453 are formed on the front side of the main body 451. The through-hole 452 vertically extends through the upper portion of the main body 451. The through-hole 453 vertically extends through the lower portion of the main body 451. A first lock-off member 480 and a second lock-off member 490 are attached in the through-holes 452 and 453, respectively.

The first lock-off member 480 and the second lock-off member 490 are respectively structured similarly to the first lock-off member 80 and the second lock-off member 90 according to the first embodiment, and therefore they will be described briefly. As illustrated in FIGS. 16, 19, and 20, the first lock-off member 480 is attached to the main body 451 via a pin 483 supported by the main body 451. The first lock-off member 480 is pivotal about the pin 483 between the first blocking position (refer to FIG. 20), at which the first lock-off member 480 blocks the operation member 450 from being moved pivotally in the clockwise direction, and the first permission position (refer to FIG. 19), at which the first lock-off member 480 permits the operation member 450 to be moved pivotally in the clockwise direction. As illustrated in FIG. 20, the first lock-off member 480 is biased by a torsion spring 484 in the counterclockwise direction (i.e., toward the first blocking position). An operation portion 481 and an engagement portion 482 respectively protrude from the lower surface and the upper surface of the upper portion of the main body 451 when the first lock-off member 480 is at the first blocking position illustrated in FIG. 20.

As illustrated in FIGS. 16, 19, and 20, the second lock-off member 490 is attached to the main body 451 via a pin 493 supported by the main body 451. The second lock-off member 490 is pivotal about the pin 493 between the second blocking position (refer to FIG. 19), at which the second lock-off member 490 blocks the operation member 450 from being moved pivotally in the counterclockwise direction, and the second permission position (refer to FIG. 20), at which the second lock-off member 490 permits the operation member 450 to be moved pivotally in the counterclockwise direction. As illustrated in FIG. 19, the second lock-off member 490 is biased by a torsion spring 494 in the clockwise direction (i.e., toward the second blocking position). An operation portion 491 and an engagement portion 492 respectively protrude from the upper surface and the lower surface of the lower portion of the main body 451 when the second lock-off member 490 is at the second blocking position illustrated in FIG. 19.

According to the grinder 410 configured in this manner, when the user performs the grip operation on the upper portion of the annular portion 441 and the upper portion of the operation member 450 while releasing the lock-off state by pivotally moving the operation portion 481 of the first lock-off member 480 from the first blocking position (refer to FIG. 20) to the first permission position (refer to FIG. 19), the operation member 450 is moved pivotally about the pin 461 in the clockwise direction against the biasing force of the spring 462, as illustrated in FIG. 19. Then, when the operation member 450 is moved pivotally in the clockwise direction to the first startup position, the protrusion 458 of the operation member 450 presses the actuator portion 472 of the first switch 471 upward, thereby displacing it. Upon detecting that, the first switch 471 is switched from the OFF state to the ON state, and the electric motor 41 is driven. On the other hand, when the user releases the operation, the operation member 450 is returned to the initial position under the biasing force of the spring 462 and the first lock-off member 480 is returned to the first blocking position under the biasing force of the torsion spring 484.

On the other hand, when the user performs the grip operation on the lower portion of the annular portion 441 and the lower portion of the operation member 450 while releasing the lock-off state by pivotally moving the operation portion 491 of the second lock-off member 490 from the second blocking position (refer to FIG. 19) to the second permission position (refer to FIG. 20), the operation member 450 is moved pivotally about the pin 461 in the counterclockwise direction against the biasing force of the spring 463, as illustrated in FIG. 20. Then, when the operation member 450 is moved pivotally in the counterclockwise direction to the second startup position, the protrusion 459 of the operation member 450 presses the actuator portion 474 of the second switch 473 downward, thereby displacing it. Upon detecting that, the second switch 473 is switched from the OFF state to the ON state, and the electric motor 41 is driven. The electric motor 41 is rotated at this time in the same direction as when the first switch 471 is switched to the ON state. On the other hand, when the user releases the operation, the operation member 450 is returned to the initial position under the biasing force of the spring 463 and the second lock-off member 490 is returned to the second blocking position under the biasing force of the torsion spring 494.

According to the above-described operation member 450, similar advantageous effects to the first embodiment can be achieved. For example, according to the operation member 450, the electric motor 41 can be driven regardless of which is subjected to the grip operation, the upper portion of the main body 451 of the operation member 450 that is located on the upper side with respect to the pin 461 (the pivotal axis AX3) or the lower portion thereof located on the lower side with respect to the pin 461. Since the pivotal axis AX3 is located between the upper portion and the lower portion, both a distance between the pivotal axis AX3 and the grip position of the upper portion of the main body 451 and a distance between the pivotal axis AX3 and the grip position of the lower portion of the main body 451 can be secured to some extent. Therefore, a rotational radius and thus a stroke amount of the operation member 450 at the grip position can be secured to some extent both when the user performs the grip operation on the upper portion and when the user performs the grip operation on the lower portion 52. As a result, excellent operability of the operation member 450 can be acquired.

Further, according to the operation member 450, the pin 461 (the pivotal axis AX3) is located at the rear edge of the operation member 450, and the first switch 471 and the second switch 473 are located at the positions corresponding to the front ends of the upper portion and the lower portion of the operation member 450, respectively. Therefore, long distances can be secured between the pivotal axis AX3, and each of the first switch 471 and the second switch 473 (i.e., the protrusions 458 and 459, which are the portions that press the first switch 471 and the second switch 473, respectively) in the front-rear direction. Therefore, a greater displacement amount can be necessitated to cause the operation member 450 to press the actuator portion 472 or 474 to bring the first switch 471 or 473 into the ON state. As a result, an erroneous operation with respect to the first switch 471 or 473 is less likely to occur.

Further, according to the operation member 450, the pin 461 (the pivotal axis AX3) of the operation member 450 is located at the rear edge of the operation member 450, and therefore a greater stroke feeling can be acquired when the grip operation is performed on the front side of the operation member 450 relatively distant from the pivotal axis AX3 than when the grip operation is performed on the rear side thereof. The operation member 450 includes the first lock-off member 480 and the second lock-off member 490 located on the front side of the operation member 450, and therefore can guide the user so as to cause the user to perform the grip operation on the front side of the operation member 450, i.e., so as to allow the user to acquire a greater stroke feeling.

Having described the embodiments of the present invention, the above-described embodiments are intended to only facilitate the understanding of the present invention, and are not intended to limit the present invention thereto. The present invention can be modified or improved without departing from the spirit thereof, and includes equivalents thereof. Further, each of the elements described in the claims and the specification can be combined in any manner or omitted in any manner within a range that allows them to remain capable of achieving at least a part of the above-described objects or bringing about at least a part of the above-described advantageous effects.

For example, in the first embodiment, the pivotal axis AX3 may be located around the boundary between the motor housing 40 and the handle housing 45 instead of being located at the connection portion 53. “Being located around the boundary” may be defined to mean, for example, being located in a trisected region closest to the boundary when three trisected regions are acquired by longitudinally trisecting a region of the motor housing 40 between the edge portion opposite from the handle housing 45 and the above-described boundary. Alternatively, “being located around the boundary” may be defined to mean, for example, being located in a trisected region closest to the boundary when three trisected regions are acquired by longitudinally trisecting a region of the handle housing 45 between the edge portion opposite from the motor housing 40 and the above-described boundary.

Alternatively, in the first embodiment, the pivotal axis AX3 may be located in a middle trisected region when three trisected regions are acquired by longitudinally trisecting the operation member 50.

Alternatively, in the first embodiment, the operation member 50 may include a protrusion portion protruding downward instead of the hinge structure. In this case, the protrusion portion may be disposed on the bottom surface of the main body housing 20, and the operation member 50 may be moved pivotally with the protrusion portion serving as a pivot point therefor.

Further, a single switch may be used instead of the first switch 71 and the second switch 73, the first switch 171 and the second switch 173, or the first switch 471 and the second switch 473. In this case, the grinder 10 or 450 may include a transmission mechanism configured to transmit the displacement of the operation member 50 or 450 to the single switch. This transmission mechanism is configured to be displaced in conjunction with the clockwise pivotal movement of the operation member 50 or 450 to press the single switch, and is configured to be displaced in conjunction with the counterclockwise pivotal movement of the operation member 50 or 450 to press the single switch. The transmission mechanism can be realized by any known mechanical element such as a link member.

Further, a single lock-off member may be used instead of the first lock-off member 80 and the second lock-off member 90 or the first lock-off member 480 and the second lock-off member 490. In this case, the single lock-off member may be configured to be displaceable between a blocking position, at which the lock-off member blocks the operation member 50 or 450 from being moved pivotally by being engaged with the operation member 50 or 450 so as to prevent the operation member 50 or 450 from being rotated in both the clockwise direction and the counterclockwise direction, and a permission position, at which the lock-off member permits both the clockwise pivotal movement and the counterclockwise pivotal movement of the operation member 50 or 450 without being engaged with the operation member 50 or 450.

Further, the pivotal axis AX3 may be located at the front edge of the operation member 450. In this case, the through-hole 442 of the handle housing 440 may be shaped so as to have a vertical width increasing toward the rear side as viewed in the left-right direction. Further, the outer edge portion of the operation member 450 may be shaped so as to have a vertical width increasing toward the rear side as viewed in the left-right direction. Further, the clearance between the inner edge portion of the annular portion 441 of the handle housing 440 and the main body 451 of the operation member 50 may increase toward the rear side.

The above-described embodiments are applicable to any work tool including a grip operation-type operation member extending elongatedly along a housing without being limited to the grinders 10 and 410.

### DESCRIPTION OF THE REFERENCE NUMERALS

10, 410 grinder
15 housing
20 main body housing
20a right housing
20b left housing
21 boss
22, 23 bolt
30 gear housing
32 bearing box
33 small bevel gear
34 large bevel gear
35 spindle
36 inner flange
37 lock nut
38 accessory tool
39 cover
40 motor housing
40a bottom surface of motor housing
41 electric motor
42 motor shaft
45 handle housing
45a connection portion
45b bottom surface of handle housing
46 rear housing
47 battery mount portion
48 battery
49 controller
50, 450 operation member
51 first portion
52 second portion
53 connection portion
54 shaft portion
55 front end portion
56 rear end portion
57, 58 elongate hole
59 first end portion-side region
60 second end portion-side region
61 recess and protrusion
62, 64 spring seat
63, 65 spring
71, 471 first switch
72, 472 actuator portion
73, 473 second switch
74, 474 actuator portion
80, 480 first lock-off member
81, 481 operation portion
82, 482 engagement portion
83, 483 pin
84, 484 torsion spring
90, 490 second lock-off member
91, 491 operation portion
92, 492 engagement portion
93, 493 pin
94, 494 torsion spring
120 main body housing
150 operation member
155 third portion
171 first switch
173 second switch
225 shaft portion
250 operation member
250a first operation member
250b second operation member
255a, 255b boss
325a, 325b shaft portion
350 operation member
350a first operation member
350b second operation member
440 handle housing
441 annular portion
442 through-hole
451 main body
452, 453 through-hole
454 pivotal axis portion
455 through-hole
456, 457 hole
458, 459 protrusion
461 pin
462, 463 spring
AX1, AX2 rotational axis
AX3 pivotal axis
AX4 first pivotal axis
AX5 second pivotal axis

1. A work tool comprising:
a motor;
a housing;
an operation member extending in a longitudinal direction of the work tool along the housing and configured to be pivotal about a pivotal axis by being subjected to a grip operation by a user, the operation member being exposed outside the housing on both a first side with respect to the pivotal axis and a second side opposite of the pivotal axis from the first side; and
a switch configured to detect that the operation member is moved pivotally to a first startup position in a first direction and to detect that the operation member is moved pivotally to a second startup position in a second direction opposite from the first direction,
wherein the work tool is configured in such a manner that the motor is driven in a case where the pivotal movement of the operation member to the first startup position is detected by the switch, and that the motor is driven in a case where the pivotal movement of the operation member to the second startup position is detected by the switch.

2. The work tool according to claim 1, wherein the first side is one side with respect to the pivotal axis in the longitudinal direction, and the second side is an opposite side of the pivotal axis from the first side in the longitudinal direction.

3. The work tool according to claim 1, wherein the first side is one side with respect to the pivotal axis in an intersection direction intersecting with the longitudinal direction, and the second side is an opposite side of the pivotal axis from the first side in the intersection direction.

4. The work tool according to claim 1, wherein the switch includes a first switch configured to detect that the operation member is moved pivotally to the first startup position, and a second switch configured to detect that the operation member is moved pivotally to the second startup position.

5. The work tool according to claim 4, wherein the first switch is disposed on the first side, and
the second switch is disposed on the second side.

6. The work tool according to claim 1, wherein the operation member includes a hinge constituent portion forming a part of a hinge for pivotally moving the operation member.

7. The work tool according to claim 6, wherein the hinge constituent portion is a shaft portion extending in a direction in which the pivotal axis extends, and rotatably supported in a boss formed in the housing.

8. The work tool according to claim 1, wherein the operation member is a single member.

9. The work tool according to claim 1, further comprising a lock-off member configured to be displaceable between a blocking position, at which the lock-off member blocks the operation member from being displaced to the first startup position and the operation member from being displaced to the second startup position, and a permission position, at which the lock-off member permits the operation member to be displaced to the first startup position and the operation member to be displaced to the second startup position.

10. The work tool according to claim 9, wherein the lock-off member includes:
a first lock-off member configured to be pivotally moved integrally with the operation member, and disposed on the first side, the first lock-off member being displaceable between a first blocking position, at which the first lock-off member is engaged with the housing, thereby blocking the operation member from being displaced to the first startup position, and a first permission position, at which the first lock-off member is not engaged with the housing, thereby permitting the operation member to be displaced to the first startup position; and
a second lock-off member configured to be pivotally moved integrally with the operation member, and disposed on the second side, the second lock-off member being displaceable between a second blocking position, at which the second lock-off member is engaged with the housing, thereby blocking the operation member from being displaced to the second startup position, and a second permission position, at which the second lock-off member is not engaged with the housing, thereby permitting the operation member to be displaced to the second startup position.

11. The work tool according to claim 2, further comprising a tool accessory configured to be driven by the motor,
wherein the housing includes:
a motor housing containing the motor therein; and
a handle housing configured to be held by the user, the handle housing being located adjacent to the motor housing on an opposite side from the tool accessory in the longitudinal direction, the handle housing extending in the longitudinal direction, and
the operation member includes a first portion extending in the longitudinal direction along the motor housing, and a second portion extending in the longitudinal direction along the handle housing.

12. The work tool according to claim 11, wherein an outer circumferential length of the handle housing around the longitudinal direction is smaller than an outer circumferential length of the motor housing around the longitudinal direction,
the operation member includes a connection portion extending in a direction intersecting with the longitudinal direction so as to follow a difference between the outer circumferential length of the handle housing and the outer circumferential length of the motor housing, thereby connecting the first portion and the second portion, and
the pivotal axis is located at the connection portion.

13. The work tool according to claim 3, wherein the housing includes an annular portion,
the operation member has an annular shape along an inner side of the annular portion, and
the pivotal axis is located at an end portion of the operation member in the longitudinal direction.

14. The work tool according to claim 4, wherein the first side is one side with respect to the pivotal axis in the longitudinal direction, and the second side is an opposite side of the pivotal axis from the first side in the longitudinal direction, and
at least one of the first switch and the second switch is located at a position where the at least one of the first switch and the second switch is pressed by an end portion of the first side or an end portion of the second side of the operation member when the operation member is moved pivotally.

15. An electric tool comprising:
a motor;
a power transmission mechanism connected to the motor;
a motor housing containing the motor therein;
a handle housing configured to be held by a user;
a gear housing containing the power transmission mechanism therein;
a tool accessory holding portion connected to the power transmission mechanism; and
an operation member extending in a longitudinal direction of the electric tool along the motor housing and the handle housing, the operation member having a pivotal center, the operation member being configured to be pivotal about the pivotal center by being subjected to a grip operation by the user,
wherein the handle housing has a smaller diameter compared to the motor housing, and includes a connection portion connecting the handle housing and the motor housing, and
the electric tool is configured in such a manner that the pivotal center is located at the connection portion.

16. The electric tool according to claim 15, wherein the handle housing is off-centered upward from the motor housing, and
the pivotal center is located at a lower portion of the connection portion.

17. The electric tool according to claim 15, wherein the operation member includes:
a first portion including a first end portion located on a first side with respect to the pivotal center in the longitudinal direction, the first portion extending in the longitudinal direction along the motor housing; and
a second portion including a second end portion located on a second side opposite of the pivotal center from the first side in the longitudinal direction, the second portion extending in the longitudinal direction along the handle housing,
wherein the first portion is shaped in such a manner that a protrusion amount of the first portion from the motor housing is maximized at a position of the first end portion, and
the second portion is shaped in such a manner that a protrusion amount of the second portion from the handle housing is maximized at a position of the second end portion.

18. The work tool according to claim 2, further comprising a tool accessory configured to be driven by the motor,
wherein the operation member includes a hinge constituent portion forming a part of a hinge for pivotally moving the operation member,
the hinge constituent portion is a shaft portion extending in a direction in which the pivotal axis extends, and rotatably supported in a boss formed in the housing,
the housing includes:
a motor housing containing the motor therein; and
a handle housing configured to be held by the user, the handle housing being located adjacent to the motor housing on an opposite side from the tool accessory in the longitudinal direction, the handle housing extending in the longitudinal direction,
the operation member includes a first portion extending in the longitudinal direction along the motor housing, and a second portion extending in the longitudinal direction along the handle housing,
an outer circumferential length of the handle housing around the longitudinal direction is smaller than an outer circumferential length of the motor housing around the longitudinal direction,
the operation member includes a connection portion extending in a direction intersecting with the longitudinal direction so as to follow a difference between the outer circumferential length of the handle housing and the outer circumferential length of the motor housing, thereby connecting the first portion and the second portion, and
the pivotal axis is located at the connection portion.

19. The work tool according to claim 18, further comprising a lock-off member configured to be displaceable between a blocking position, at which the lock-off member blocks the operation member from being displaced to the first startup position and the operation member from being displaced to the second startup position, and a permission position, at which the lock-off member permits the operation member to be displaced to the first startup position and the operation member to be displaced to the second startup position,
wherein the lock-off member includes:
a first lock-off member configured to be pivotally moved integrally with the operation member, and disposed on the first side, the first lock-off member being displaceable between a first blocking position, at which the first lock-off member is engaged with the housing, thereby blocking the operation member from being displaced to the first startup position, and a first permission position, at which the first lock-off member is not engaged with the housing, thereby permitting the operation member to be displaced to the first startup position; and
a second lock-off member configured to be pivotally moved integrally with the operation member, and disposed on the second side, the second lock-off member being displaceable between a second blocking position, at which the second lock-off member is engaged with the housing, thereby blocking the operation member from being displaced to the second startup position, and a second permission position, at which the second lock-off member is not engaged with the housing, thereby permitting the operation member to be displaced to the second startup position.

20. The work tool according to claim 3, wherein the operation member includes a hinge constituent portion forming a part of a hinge for pivotally moving the operation member,
the hinge constituent portion is a shaft portion extending in a direction in which the pivotal axis extends, and rotatably supported in a boss formed in the housing,
the housing includes an annular portion,
the operation member has an annular shape along an inner side of the annular portion, and
the pivotal axis is located at an end portion of the operation member in the longitudinal direction.
